(19) United States
(12) Patent Application Publication
(10) Pub. No.: US 2006/0057281 A1
(43) Pub. Date: Mar. 16, 2006

(54) Method for manufacturing membrane electrode assembly for fuel cell

(76) Inventors: Shintaro Izumi, Osaka (JP); Nobuyuki Kamikihara, Osaka (JP); Masaru Watanabe, Hyogo (JP); Yusuke Ozaki, Osaka (JP); Miho Kobayashi, Osaka (JP); Yasuhiro Ueyama, Hyogo (JP)

Correspondence Address: RATNERPRESTIA, P O BOX 980, VALLEY FORGE, PA, 19482-0980, US

(21) Appl. No.: 10/523,324

(22) PCT Filed: Jul. 28, 2003
(86) PCT No.: PCT/JP03/09511

§ 371 Date: Jan. 28, 2005

(30) Foreign Application Priority Data
Jul. 29, 2002 (JP) 2002-220214
Aug. 28, 2002 (JP) 2002-249644

(51) Int. Cl. B05D 5/12; H01M 4/88; H01M 8/10

(52) U.S. Cl. 427/115; 502/101; 429/30

(57) ABSTRACT

A method of producing a membrane-electrode assembly for a fuel cell remarkably enhances the productivity and properties of fuel cell. There are provided in the method a first catalyst layer forming step of spreading a first coating compound over a running substrate to form a first catalyst layer, an electrolyte forming step of spreading a second coating compound over said first catalyst layer while the first catalyst layer is wet to form an electrolyte layer, a drying step of drying the electrolyte layer, and a second catalyst layer forming step of spreading a third coating compound having a noble metal supported thereon over the dried electrolyte layer to form a second catalyst layer.

### TECHNICAL FIELD

The present invention relates to a fuel cell membrane-electrode assembly producing method and apparatus of producing a membrane-electrode assembly for fuel cell for use in solid polymer type fuel cell, a membrane-electrode assembly, a polymer electrolyte coating compound for fuel cell and a polymer electrolyte type fuel cell.

### BACKGROUND ART

A fuel cell causes a fuel gas containing hydrogen and an oxidizing gas containing oxygen or the like to react electrochemically with each other to generate electric power energy. Examples of the fuel cell include phosphoric acid type fuel cells, molten carbonate type fuel cells, oxide type fuel cells and polymer electrolyte type fuel cells.

A polymer electrolyte type fuel cell (PEFC) can cause a fuel gas containing hydrogen and an oxidizing gas containing oxygen such as air to react electrochemically with each other to generate electric power and heat at the same time. The fuel gas and the oxidizing gas are altogether called reactive gas as well.

PEFC is a fuel cell comprising a polymer electrolyte membrane as an electrolyte and said polymer electrolyte membrane allows selective conduction of hydrogen ion. Further, PEFC comprises an assembly having a pair of electrodes laminated on each other with said polymer electrolyte membrane interposed therebetween. Such an assembly comprising a polymer electrolyte membrane and a pair of electrodes is called membrane-electrode assembly (MEA). Said electrode in MEA comprises a catalyst layer containing a catalyst for promoting electrochemical reaction. It suffices if said catalyst layer comes in contact with the polymer electrolyte membrane.

At present, as an electrode there is widely used a porous electrode comprising a catalyst layer and a gas diffusion layer. As said catalyst layer, a catalyst comprising a carbon powder having a noble metal supported thereon as a main component is widely used. Further, as said gas diffusion layer, a carbon paper or the like having electrical conductivity and permeability to reactive gas is widely used.

In an actual cell, an electrically-conductive separator having a gas flow path formed there in is disposed on the both sides of said MEA. Said separator acts to supply the reactive gas into MEA and carry a gas produced by the cell reaction and extra reactive gas away. Such a structure comprising MEA and a pair of separators is called single cell.

When a plurality of single cells thus obtained are laminated on each other, a laminated cell which outputs a voltage of from few volts to hundreds of volts depending on the number of laminated layers can be obtained. Such a laminated cell is called fuel cell stack (or usually fuel cell).

In MEA, the fuel electrode (anode) and the oxidizing agent electrode (cathode) cause reactions represented by the following formulae, respectively.
Anode: H₂→2H⁺+2e⁻
Cathode: ½O₂+2H⁺+2e⁻+H₂O

The electron generated at the anode moves to the cathode through an external circuit. At the same time, the hydrogen ion generated at the anode moves to the cathode through the polymer electrolyte membrane to generate electricity.

The membrane-electrode assembly constituting the polymer electrolyte type fuel cell is composed of an electrolyte layer and a catalyst layer disposed on the both sides of the electrolyte layer as mentioned above, and one of the catalyst layers is called hydrogen electrode and the other is called oxygen electrode.

When hydrogen is supplied into the hydrogen electrode and oxygen is supplied into the oxygen electrode, the hydrogen becomes hydrogen ion in the presence of the catalyst in the hydrogen electrode and moves through the electrolyte layer to the oxygen electrode where it then undergoes catalytic reaction with oxygen to produce water. During this process, electron moves from the oxygen electrode to the hydrogen electrode.

Such a membrane-electrode assembly is prepared in the following manner.

In other words, FIGS. 10 to 13 illustrate a related art method of producing a membrane-electrode assembly. This production method is hereinafter referred to as related art printing process.

Firstly, in the related art printing process, a molten polymer electrolyte 15 is extruded through a extruder 17 in a band form onto a substrate 9a as shown in FIG. 10 to form a sheet of polymer electrolyte comprising the substrate 9a and the polymer electrolyte 15 formed on the substrate 9a.

Subsequently, a sheet of first catalyst layer comprising a substrate 9b and a first catalyst layer 201 (hydrogen electrode) formed on the substrate 9b is slit into a desired shape as shown in FIG. 11. This sheet of first catalyst layer has been formed at a production step similar to the extrusion described in FIG. 10. The first catalyst layer 201 acts as a hydrogen electrode.

Further, as shown in FIG. 12 the sheet of first catalyst layer which has been slit at the step of FIG. 11 is thermally transferred onto the sheet of polymer electrolyte formed at the step of FIG. 10. In other words, the sheet of first catalyst layer which has been slit is hot-pressed onto the polymer electrolyte 301 formed on the substrate 9a over a thermal transfer roll. To be short, the first catalyst layer 201 is hot-pressed onto the polymer electrolyte layer 301 over a thermal transfer roll. Thus, hot-pressing by the thermal transfer roll 18 causes the first catalyst layer 201 to be thermally transferred onto the polymer electrolyte layer 301.

Finally, the polymer electrolyte layer 301 and the first catalyst layer 201 which have been subjected to thermal transfer in FIG. 12 are reversed, and the substrate 9a of the sheet of polymer electrolyte is then removed as shown in FIG. 13. Then, a printing mold 19 is disposed on the polymer electrolyte layer 301, the printing mold 19 is filled with a coating compound for second catalyst layer 401, and excessive coating compound is then removed by sweeping a printing cutting edge 20. Thus, the second catalyst layer 401 is formed by printing. The second catalyst layer 401 acts as an oxygen electrode. As the coating compound for the second catalyst layer 401 there is used one obtained by mixing a carbon powder having a noble metal supported on a particulate carbon black as a catalyst material with a binder resin and a solvent.

Thus, when the steps of FIGS. 10 to 13 have been effected, a membrane-electrode assembly comprising the first catalyst layer 201, the polymer electrolyte layer 301 and the second catalyst layer 401 is then produced.

Said printing process has been described with reference to the case where the thermal transfer of the sheet of first catalyst layer onto the sheet of polymer electrolyte is followed by printing of the second catalyst layer 401 on the sheet of polymer electrolyte. While said printing process has been described, in other words, with reference to the case where the first catalyst layer 201 is formed by transferring and the second catalyst layer 401 is formed by printing, the present invention is not limited thereto, but both the first catalyst layer 201 and second catalyst layer 401 may be formed by transferring or printing. Referring to the order of formation of the first catalyst layer 201 and the second catalyst layer 401, any of the two catalyst layers may be first formed, and in this case, the first catalyst layer 201 and the second catalyst layer 401 may be formed by any of transferring and printing.

Next, a method of producing a membrane-electrode assembly different from said printing process will be described in connection with FIG. 14. This production method will be hereinafter referred to as related art roll process. In FIG. 14, the reference numeral 1 indicates a nozzle, the reference numeral 5 indicates a coating compound supplying unit, the reference numeral 9 indicates a substrate, the reference numeral 10 indicates a roll, and the reference numeral 11 indicates a coating compound for first catalyst layer. Further, the coating compound supplying unit 5 is composed of a tank 501 and a pump 502. As the compound 11 for first catalyst layer there is used one obtained by mixing a carbon powder having a noble metal supported on a particulate carbon black as a catalyst material with a binder resin and a solvent.

Next, the related art roll process will be described.

The tank 501 has the coating compound 11 for first catalyst layer stored therein. The coating compound 11 for first catalyst layer is passed through the pump 502 to the nozzle 1 through which it is then continuously spread over a hoop-shaped substrate 9 running over the roll 10 in a band form. The coating compound 11 for first catalyst layer may be intermittently spread over the substrate 9. The substrate 9 over which the coating compound 11 for first catalyst layer has been spread is dried, and then wound temporarily. Thus, the first catalyst layer is formed on the substrate 9.

Subsequently, a coating compound for electrolyte layer is spread over the substrate 9 thus wound on the surface thereof on which the first catalyst layer has been formed in a band form in the same manner as shown in FIG. 14. Subsequently, the substrate 9 over which the coating compound for electrolyte layer has been spread is dried, and then wound temporarily. Thus, the two layers, i.e., first catalyst layer and electrolyte layer are formed on the substrate 9.

Subsequently, a coating compound for second catalyst layer is spread over the substrate 9 thus wound on the surface thereof on which the electrolyte layer has been formed in a band form in the same manner as shown in FIG. 14. Subsequently, the substrate 9 over which the coating compound for second catalyst layer has been spread is dried, and then wound temporarily. Thus, the three layers, i.e., first catalyst layer, electrolyte layer, second catalyst layer are formed on the substrate 9.

Lastly, the first catalyst layer, electrolyte layer and second catalyst layer formed on the substrate 9 are slit into a desired shape to obtain a membrane-electrode assembly.

While FIG. 14 has been described with reference to the case where a membrane-electrode assembly is produced using the nozzle 1, a printing cutting edge 20, a plate 21 forming the bottom of liquid reserve and a cutting blade 22 for adjusting the thickness of coat layer may be used instead of the nozzle 1 as shown in FIG. 15. The method of FIG. 15 is the same as the production method of FIG. 14 except that the printing cutting edge 20, the plate 21 and the cutting edge 22 are used in place of the nozzle 1 and the description thereof will be omitted.

Further, when the related art membrane-electrode assembly is used to generate electricity, the first catalyst layer (hydrogen electrode) undergoes reaction much more than the second catalyst layer (oxygen electrode) does. Accordingly, in the case where the first catalyst layer (hydrogen electrode) and the second catalyst layer (oxygen electrode) have the same amount of catalyst, the amount of hydrogen ion produced by the first catalyst layer (hydrogen electrode) is excessive, deteriorating the efficiency. Therefore, it has been devised to incorporate a noble metal catalyst such as platinum in the second catalyst layer (oxygen electrode) more than in the first catalyst layer (hydrogen electrode) or form the second catalyst layer (oxygen electrode) thicker than the first catalyst layer (hydrogen electrode).

Further, as a method of producing a membrane-electrode assembly different from the method described above there is a method called hot-pressing method. In some detail, firstly, a catalyst is mixed with a solvent and a resin which is a binder to prepare a catalyst coating compound. Subsequently, said catalyst coating compound is spread and dried over a gas diffusion layer such as carbon paper which has been subjected to water repellent treatment to form a catalyst layer. Thus, a porous electrode is prepared. Subsequently, the porous electrode thus prepared is bonded to the polymer electrolyte layer on the both sides thereof by hot-pressing or the like to complete MEA.

Further, as previously mentioned partly, as a method of producing a membrane-electrode assembly there is a method called transferring process. In other words, there are exemplified a method which comprises spreading a catalyst coating compound over the surface of a polymer electrolyte layer, and drying the coat layer to form a catalyst layer directly, a method which comprises previously preparing a catalyst layer on a substrate such as film, and then transferring the catalyst layer onto a polymer electrolyte layer, etc.

However, the related art printing process and related art roll process are disadvantageous in that since the first catalyst layer, the electrolyte layer and the second catalyst layer are separately spread and formed, the productivity is reduced.

Further, in the related art roll process, the first catalyst layer must be completely dried before being wound. In the case where the first catalyst layer is completely dried before being wound, a large number of voids are formed in the first catalyst layer to form a layer having a high porosity. Accordingly, when the coating compound which is a raw material of electrolyte layer is spread over the first catalyst layer, the coating compound for electrolyte layer penetrates the voids formed in the first catalyst layer, occasionally resulting in the deterioration of electrical properties.

In other words, the related art roll process is disadvantageous in that the coating compound for electrolyte layer penetrates the voids formed by the drying of the first catalyst layer to deteriorate electrical properties.

Further, in the related art roll process, in the case where the coating compound which is a raw material of electrolyte layer and the coating compound which is a raw material of second catalyst layer are simultaneously spread, said coating compound which is a raw material of electrolyte layer flows to disturb the thickness of the electrolyte layer or the first catalyst layer and the second catalyst layer come in contact with each other, occasionally resulting in the deterioration of electrical properties. In other words, the coating compound which is a raw material of electrolyte layer has a lower viscosity than the coating compound which is a raw material of second catalyst layer. Accordingly, the coating compound which is a raw material of electrolyte layer can flow more easily than the coating compound which is a raw material of second catalyst layer. Thus, the electrical properties are deteriorated.

In other words, the related art roll process is disadvantageous in that the simultaneous spreading of the coating compound which is a raw material of electrolyte layer and the coating compound which is a raw material of second catalyst layer causes the deterioration of electrical properties and thus is made impossible.

Further, while the related art membrane-electrode assembly has been devised such that the second catalyst layer has a noble metal such as platinum incorporated therein more than the first catalyst layer or the second catalyst layer has a greater thickness than the first catalyst layer, it has been desired to further reduce the internal resistivity of the membrane-electrode assembly.

In other words, it has been desired to reduce the internal resistivity of the membrane-electrode assembly more than ever.

Further, it is possible that said related art hot-pressing and transferring processes have the following disadvantages.

1. In the case where the separate preparation of the polymer electrolyte layer and/or the catalyst layer is followed by pressing or the like, a large number of steps are required, making it difficult to raise the productivity of MEA.

2. In the case where the bonding of the various layers constituting MEA is effected after the preparation of the various layers, the bonding of the catalyst layer to the polymer electrolyte layer requires close adjustment and a minute gap can be formed between the interface of the two layers, occasionally causing the separation of the catalyst layer and the polymer electrolyte layer from each other. In the case where such MEA is used, the properties of cell cannot be sufficiently attained.

3. In the case where the catalyst coating compound is directly spread over the surface of the polymer electrolyte layer, a good MEA cannot be occasionally obtained because the mechanical strength of the polymer electrolyte layer is normally small or the polymer electrolyte layer is dissolved in or swells with the solvent components contained in the catalyst coating compound. In this case, the catalyst layers having the polymer electrolyte layer provided interposed therebetween can be short-circuited to each other to cause leakage or the like.

As a method of solving the aforementioned problems there has been developed a “simultaneous spreading process” which comprises sequentially and almost simultaneously spreading and laminating a catalyst coating compound, a polymer electrolyte coating compound and a catalyst coating compound on a substrate. In the simultaneous spreading process, the subsequent coating compound is spread before the drying of each layer comprising a coating compound (coating compound layer) and all the layers laminated are then dried altogether, making it difficult for the catalyst layer and polymer electrolyte layer thus dried to separate from each other. Further, the number of steps can be reduced, and when the substrate is continuously conveyed, it is also made possible to continuously produce MEA, making it possible to raise productivity.

However, said simultaneous spreading process can undergo serious cracking on the surface of the catalyst layer which is an uppermost layer (catalyst layer formed on the polymer electrolyte layer). This is presumably attributed to the mechanism that the volumetric contraction of the catalyst coating compound layer during drying is affected by the fluidity of the polymer electrolyte layer disposed thereunder, causing the development to serious cracking on the surface of the catalyst layer dried. In the case where serious cracking occurs on the surface of the catalyst layer, the catalyst density of the catalyst layer can be reduced or the catalyst layer can fall off at the cracked site, occasionally deteriorating the discharge rate or cycle life properties of the cell.

### DISCLOSURE OF THE INVENTION

Taking into account said problems, the present invention has an object of providing a method of producing a membrane-electrode assembly for fuel cell, an apparatus of producing a membrane-electrode assembly for fuel cell and a membrane-electrode assembly which remarkably enhances the productivity and properties of fuel cell.

In other words, taking into account said problems, the present invention has an object of providing a method of producing a membrane-electrode assembly for fuel cell and an apparatus of producing a membrane-electrode assembly for fuel cell having a high productivity.

Further, taking into account said problems, the present invention has an object of providing a method of producing a membrane-electrode assembly for fuel cell and an apparatus of producing a membrane-electrode assembly for fuel cell which is not subject to deterioration of electrical properties caused by the penetration of a coating compound of electrolyte layer in voids formed in a first catalyst layer.

Further, taking into account said problems, the present invention has an object of providing a method of producing a membrane-electrode assembly for fuel cell and an apparatus of producing a membrane-electrode assembly for fuel cell which is not subject to deterioration of electrical properties even if a coating compound which is a raw material of electrolyte and a coating compound which is a raw material of second coating compound are spread at the same time.

Further, taking into account said problems, the present invention has an object of providing a membrane-electrode assembly for fuel cell having a lower internal resistivity than ever.

Further, taking into account said problems, the present invention has an object of providing a membrane-electrode assembly for fuel cell, a method of producing a membrane-electrode assembly for fuel cell, a polymer electrolyte coating compound for fuel cell and a polymer electrolyte type fuel cell which undergoes no great cracking on the surface of a catalyst layer which is an uppermost layer and hence no deterioration of cell discharge rate or cycle life.

In order to solve the above-described problems, the first present invention concerns a method of producing a membrane-electrode assembly for fuel cell comprising:
a first catalyst layer forming step of spreading a first coating compound over a running substrate to form a first catalyst layer;
an electrolyte forming step of spreading a second coating compound over said first catalyst layer while said first catalyst layer is wet to form an electrolyte layer;
a drying step of drying said electrolyte layer such that the thickness of said electrolyte layer kept in wet state reaches a predetermined value; and
a second catalyst layer forming step of spreading a third coating compound over said dried electrolyte layer to form a second catalyst layer, wherein said first catalyst layer and said second catalyst layer are a hydrogen electrode and an oxygen electrode, respectively, or an oxygen electrode and a hydrogen electrode, respectively.

Further, the second present invention concerns the method of producing a membrane-electrode assembly for fuel cell as described in the first present invention, wherein said drying step is effected at a drying temperature of from not lower than 20° C. to not higher than 150° C.

Further, the third present invention concerns the method of producing a membrane-electrode assembly for fuel cell as described in the first or second present invention, wherein said drying step is effected with the distance between the outlet of hot air and said electrolyte layer falling within the range of from not smaller than 10 mm to not greater than 500 mm.

Further, the fourth present invention concerns the method of producing a membrane-electrode assembly for fuel cell as described in claim 3, wherein said drying step is effected with the hot air flow rate at a position of 10 mm from said outlet of hot air falling within the range of from not smaller than 1 m per second to not greater than 20 m per second.

Further, the fifth present invention concerns an apparatus of producing a membrane-electrode assembly for fuel cell comprising:
a first catalyst layer forming unit of spreading a first coating compound over a running substrate to form a first catalyst layer;
an electrolyte forming unit of spreading a second coating compound over said first catalyst layer thus formed while said first catalyst layer is wet to form an electrolyte layer;
a drying unit of drying said electrolyte layer such that the thickness of said electrolyte layer kept in wet state reaches a predetermined value; and
a second catalyst layer forming unit of spreading a third coating compound over said dried electrolyte layer to form a second catalyst layer,
   wherein said first catalyst layer and said second catalyst layer are a hydrogen electrode and an oxygen electrode, respectively, or an oxygen electrode and a hydrogen electrode, respectively.

Further, the sixth present invention concerns a membrane-electrode assembly for fuel cell comprising:
a hydrogen electrode;
   wherein said oxygen electrode has a larger area in contact with said electrolyte layer than said hydrogen electrode.

Further, the seventh present invention concerns a method of producing a membrane-electrode assembly for fuel cell comprising:
a first step of spreading a first coating compound comprising a first catalyst and a resin having hydrogenionic conductivity over a substrate to form a first layer;
a second step of spreading a second coating compound comprising a resin having hydrogenionic conductivity over said first layer to form a second layer; and
a third step of spreading a third coating compound comprising a second catalyst, a resin having hydrogenionic conductivity and a solvent over said second layer before drying of said second layer to form a third layer and prepare a laminate comprising said first layer, said second layer and said third layer,
   wherein said solvent contains an organic solvent having a boiling point of 120° C. or more at 1 atm in a proportion of 40% by weight or more; and
   90% or more of the drying step of drying said laminate is effected at a temperature of from 60° C. to 80° C.

Further, the eighth present invention concerns a method of producing a membrane-electrode assembly for fuel cell comprising:
a first step of spreading a first coating compound comprising a first catalyst and a resin having hydrogenionic conductivity over a substrate to form a first layer;
a second step of spreading a second coating compound comprising a resin having hydrogenionic conductivity over said first layer to form a second layer; and
a third step of spreading a third coating compound comprising a second catalyst, a resin having hydrogenionic conductivity and a solvent over said second layer before drying of said second layer to form a third layer and prepare a laminate comprising said first layer, said second layer and said third layer,
   wherein said solvent contains an organic solvent having a saturated vapor pressure of 1.06 kPa (8 mmHg) or less at 20° C. in a proportion of 40% by weight or more; and 90% or more of the drying step of drying said laminate is effected at a temperature of from 60° C. to 80° C.

Further, the ninth present invention concerns a method of producing a membrane-electrode assembly for fuel cell of the eighth present invention, wherein said solvent contains an organic solvent having a saturated vapor pressure of 0.20 kPa (1.5 mmHg) or less at 20° C.

Further, the tenth present invention concerns a method of producing a membrane-electrode assembly for fuel cell of any one of the seventh to ninth present inventions, wherein said organic solvent contains a compound represented by the following general formula (A):
R₁—O—(R₂O)ₙ—H (A)
wherein R₁ is one functional group selected from CH₃, C₂H₅, C₃H₇ and C₄H₉;
R₂ is one functional group selected from C₂H₄ and C₃H₆; and
n is one integer selected from 1, 2 and 3.

The eleventh present invention concerns a method of producing a membrane-electrode assembly for fuel cell comprising:
a first step of spreading a first coating compound comprising a first catalyst and a resin having hydrogenionic conductivity over a substrate to form a first layer;
a second step of spreading a second coating compound comprising a resin having hydrogenionic conductivity over said first layer to form a second layer; and
a third step of spreading a third coating compound comprising a second catalyst, a resin having hydrogenionic conductivity and a solvent over said second layer to form a third layer and prepare a laminate comprising said first layer, said second layer and said third layer,
   wherein said second coating compound contains a gelatinizing agent.

Further, the twelfth present invention concerns a method of producing a membrane-electrode assembly for fuel cell of the eleventh present invention, wherein said gelatinizing agent is a temperature-sensitive gelatinizing agent.

Further, the thirteenth present invention concerns a method of producing a membrane-electrode assembly for fuel cell of the eleventh or twelfth present invention, wherein said second coating compound contains said gelatinizing agent in a proportion of 33% by weight or less.

Further, the fourteenth present invention concerns a method of producing a membrane-electrode assembly for fuel cell of any one of the seventh, eighth and eleventh present inventions, wherein said second compound contains a thickening agent in a proportion of 33% by weight or less.

The fifteenth present invention concerns a method of producing a membrane-electrode assembly for fuel cell of any one of the seventh, eighth and eleventh present inventions, wherein the viscosity 1i of said second coating compound at a temperature of 25° C. and a shear rate of 1 s⁻¹ and the viscosity η₂ of said third coating compound at a temperature of 25° C. and a shear rate of 1 s⁻¹ satisfy the following relationship:
1/25≦η₁/η₂≦25
wherein η₁ and η₂ each are greater than 0.

Further, the sixteenth present invention concerns a method of producing a membrane-electrode assembly for fuel cell of the fifteenth present invention, wherein said η₁ and said η₂ satisfy the relationship η₁>η₂.

Further, the seventeenth present invention concerns a method of producing a membrane-electrode assembly for fuel cell of any one of the seventh, eighth and eleventh present inventions, wherein said second catalyst is a solid material having a noble metal supported thereon; and said third coating compound is a coating compound obtained by a step comprising kneading said second catalyst and a first solvent which is at least one component of said solvent with the proportion of said second catalyst being 20% by weight or more.

Further, the eighteenth present invention concerns a method of producing a membrane-electrode assembly for fuel cell of the seventeenth present invention, wherein said first solvent is a solvent having the highest affinity for said catalyst among said solvent components.

Further, the nineteenth present invention concerns a method of producing a membrane-electrode assembly for fuel cell of any one of the seventh, eighth and eleventh present inventions, wherein said first step, said second step and said third step are sequentially effected while said substrate is being continuously carried.

Further, the twentieth present invention concerns a polymer electrolyte type fuel cell comprising a membrane-electrode assembly for fuel cell produced by a method of producing a membrane-electrode assembly for fuel cell of any one of the seventh, eighth and eleventh present inventions and a separator through which a reactive gas is supplied into said membrane-electrode assembly for fuel cell.

Further, the twenty-first present invention concerns a polymer electrolyte coating compound for fuel cell comprising a resin having hydrogenionic conductivity, a second solvent capable of dissolving said resin therein and a gelatinizing agent.

Further, the twenty-second present invention concerns a polymer electrolyte coating compound for fuel cell of the twenty-first present invention, wherein said gelatinizing agent is a temperature-sensitive gelatinizing agent.

Further, the twenty-third present invention concerns a polymer electrolyte coating compound for fuel cell of the twenty-first or twenty-second present invention, wherein said gelatinizing agent is incorporated in a proportion of 33% by weight or less.

Further, the twenty-fourth present invention concerns a membrane-electrode assembly for fuel cell comprising a pair of catalyst layers laminated on each other with a polymer electrolyte layer having hydrogenionic conductivity interposed therebetween, wherein said polymer electrolyte layer is porous.

Further, the twenty-fifth present invention concerns a polymer electrolyte type fuel cell comprising a membrane-electrode assembly for fuel cell of the twenty-fourth present invention and a separator through which a reactive gas is supplied into said membrane-electrode assembly for fuel cell.

### BRIEF DESCRIPTION OF THE DRAWINGS

FIG. 1 is a schematic diagram of a membrane-electrode assembly according to a first embodiment of implementation of the present invention.

FIG. 2 is a schematic diagram illustrating an apparatus of producing a membrane-electrode assembly according to the first embodiment of implementation of the present invention.

FIG. 3 is a sectional view of a membrane-electrode assembly according to the first embodiment of implementation of the present invention.

FIG. 4 is a typical diagram illustrating a method of producing a membrane-electrode assembly according to the present invention.

FIG. 5 is a typical diagram illustrating an example of a coating device for use in a method of producing a membrane-electrode assembly according to the present invention.

FIG. 6 is a typical diagram illustrating an example of the configuration of a membrane-electrode assembly according to the present invention.

FIG. 7 is a sectional view illustrating an example of the configuration of a membrane-electrode assembly according to the present invention.

FIG. 8 is a typical diagram illustrating an example of a method of producing a membrane-electrode assembly according to the present invention.

FIG. 9 is a typical diagram illustrating an example of the configuration of a fuel cell according to the present invention.

FIG. 10 is a diagram illustrating a step of producing a membrane-electrode assembly by a related art printing process.

FIG. 11 is a diagram illustrating a step of producing a membrane-electrode assembly by a related art printing process.

FIG. 12 is a diagram illustrating a step of producing a membrane-electrode assembly by a related art printing process.

FIG. 13 is a diagram illustrating a step of producing a membrane-electrode assembly by a related art printing process.

FIG. 14 is a diagram illustrating a step of producing a membrane-electrode assembly by a related art roll process.

FIG. 15 is a diagram illustrating a step of producing a membrane-electrode assembly by a related art roll process.

### DESCRIPTION OF SIGNS

1, 2 Nozzle
3a, 3b Sacbag
4 Drying unit
5, 6, 7 Coating compound supplying unit
9, 9a, 9b Substrate
10 Roll
11 Coating compound for first catalyst layer
12 Coating compound for polymer electrolyte layer
13 Coating compound for second catalyst layer
15 Polymer electrolyte
16 Mold for extrusion
17 Extrusion machine
18 Heat transfer roll
19 Printing mold
20 Printing cutting edge
21 Plate
22 Cutting edge
201 First catalyst layer
301 Polymer electrolyte layer
401 Second catalyst layer
202, 302, 402 Slit
501, 303, 403 Manifold
501, 601, 701 Tank
502, 602, 702 Pump
503, 703 Three-way valve
1001, 1101 Substrate
1002, 1004, 1102, 1104 Catalyst coating compound
1003, 1103 Polymer electrolyte coating compound
1021, 1041, 1121, 1141 Catalyst coat layer
1031, 1131 Polymer electrolyte coat layer
1022, 1042, 1122, 1142 Catalyst layer
1032, 1132 Polymer electrolyte layer
1051, 1052, 1053, 1055, 1151, 1152, 1153 Coating device
1054, 1154 Drying device
1231 Membrane-electrode assembly
1232, 1233 Gas diffusion layer
1234, 1235 Separator

### BEST MODE FOR CARRYING OUT THE INVENTION

Embodiments of implementation of the present invention will be described hereinafter in connection with the drawings.

### Embodiment 1

Firstly, Embodiment 1 will be described.

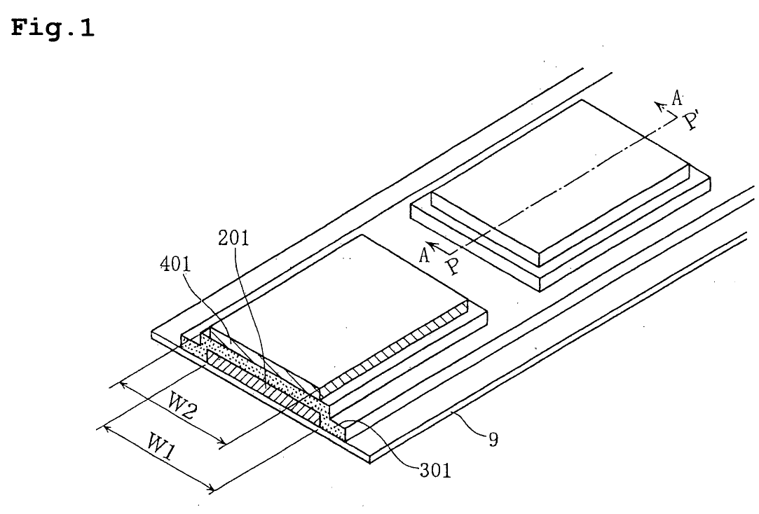

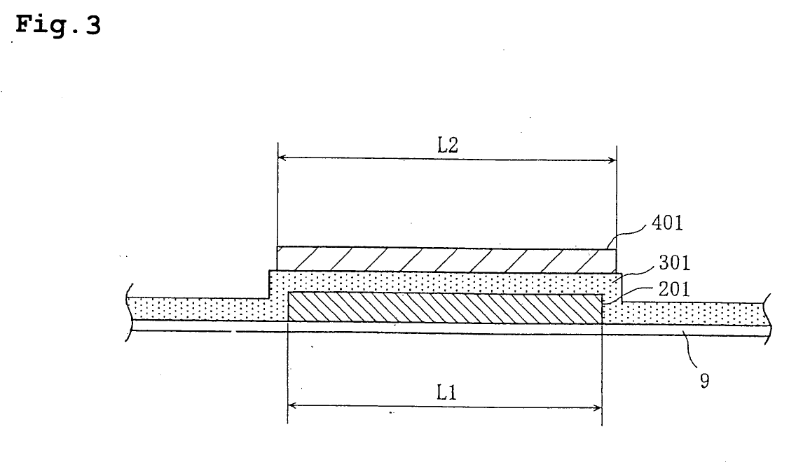

FIG. 1 illustrates a schematic configurational diagram of a membrane-electrode assembly for use in the present embodiment. Further, FIG. 3 illustrates a sectional view taken in the line PP′. The reference numeral 9 is a substrate to be used in the continuous preparation of a membrane-electrode assembly and various layers are formed on the substrate.

The reference numeral 201 is a first catalyst layer which is formed on the substrate 9. Further, the reference numeral 301 is a polymer electrolyte layer which is formed on the first catalyst layer 201. Further, the reference numeral 401 is a second catalyst layer which is formed on the polymer electrolyte layer 301.

By the way, the first catalyst layer 201 is used as a hydrogen electrode and the second catalyst layer 401 is used as an oxygen electrode.

The membrane-electrode assembly to be used in the present embodiment is prepared in the following manner.

In other words, the substrate 9 made of polyethylene terephthalate or polypropylene is continuously running. A coating compound obtained by mixing a noble metal-on-carbon powder having a catalyst such as platinum and platinum alloy supported thereon, a fluororesin having hydrogenionic conductivity and a solvent is extruded through the slit of a nozzle onto and spread over the continuously running substrate 9 in a band form to form a first catalyst layer 201.

As the carbon powder there may be used an electrically-conductive carbon black such as acetylene black and ketjen black.

Further, as the fluororesin there may be used a polyethylene terephthalate, polyvinylidene fluoride, polyvinylidene fluoride-hexafluoropropylene copolymer, perfluorosulfonic acid, etc., singly or in combination.

Next, as the solvent there may be used water, ethylene alcohol, methyl alcohol, isopropyl alcohol, ethylene glycol, methylene glycol, propylene glycol, methyl ethyl ketone, acetone, toluene, xylene, n methyl-2-pyrrolidone, etc., singly or in combination. Further, the added amount of the solvent may be from 10 to 3,000 based on 100 of carbon powder by weight ratio.

At the same time with the formation of the first catalyst layer 201, a coating compound comprising a fluororesin having hydrogenionic conductivity as a main component is extruded through the slit of a nozzle onto and spread over the first catalyst layer 201 in a band form to form a two-layer laminate comprising the first catalyst layer 201 and the polymer electrolyte 301. Since the polymer electrolyte layer 301 is formed while the first catalyst layer 201 is wet, the coating compound of the polymer electrolyte layer 301 doesn't penetrate the first catalyst layer 201.

Subsequently, the two-layer laminate comprising the first catalyst layer 201 and the polymer electrolyte 301 is dried by a drying unit to dry the surface of the polymer electrolyte layer 301.

Subsequently, a coating compound obtained by mixing a noble metal-on-carbon powder, a resin having hydrogenionic conductivity and a solvent is extruded through the slit of a nozzle and spread over the polymer electrolyte layer 301 in a band form to form a second catalyst layer 401 on the polymer electrolyte layer 301. The average thickness of the first catalyst layer 201 and the second catalyst layer 401 each are preferably from 3 to 160 μm and the average thickness of the polymer electrolyte layer is preferably from 6 to 200 μm.

Thus, a band-shaped material comprising three layers laminated on each other (hereinafter referred to as “three-layer laminated band”) is formed. In order to spread the coating compound, it is necessary that the width W1 of the first catalyst layer 201 and the width W2 of the second catalyst layer 401 satisfy the relationship W1≦W2. In other words, it is necessary that the first catalyst layer 201 and the second catalyst layer 401 be formed such that the width of the second catalyst layer 401 is not smaller than the width of the first catalyst layer 201.

Finally, the three-layer laminated band is peeled off the substrate 9, and then stamped to a predetermined shape so that a three-layer laminated material having a three-layer structure, i.e., membrane-electrode assembly is prepared.

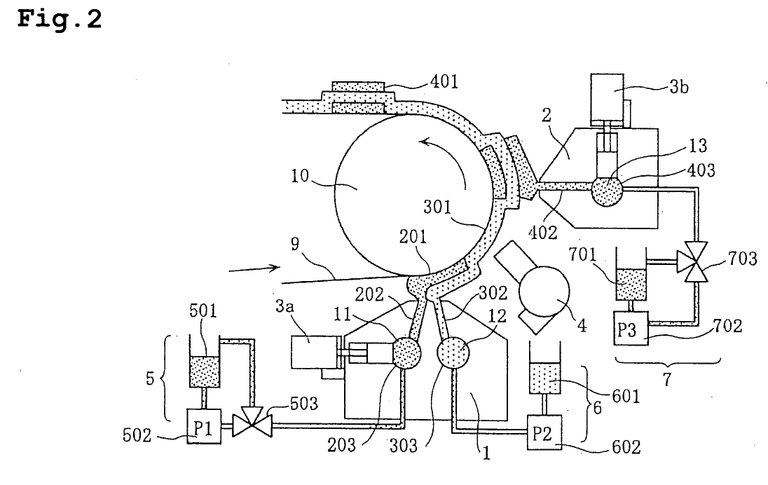

FIG. 2 illustrates a schematic diagram of an apparatus of producing a membrane-electrode assembly for use in the present embodiment. Firstly, the configuration of the apparatus of producing a membrane-electrode assembly will be described. The reference numerals 1, 2 each indicate a nozzle through which a coating compound is ejected onto the substrate 9, the reference numeral 11 indicates a coating compound for the first catalyst layer, the reference numeral 12 indicates a coating compound for polymer electrolyte, the reference numeral 13 indicates a coating compound for the second catalyst layer, the reference numerals 202, 302, 402 each indicate a slit, the reference numerals 203, 303, 403 each indicate a manifold, the reference numerals 3a, 3b each indicate a sacbag device, the reference numeral 4 indicates a drying unit, and the reference numerals 5, 6, 7 each indicate a coating compound supplying device.

Here, the sacbag devices 3a, 3b are a unit which sucks the coating compound from the interior of the various manifolds 203, 303, 403 to spread the coating compound intermittently through the slits 202, 302, 402 of the nozzles 1, 2, respectively.

The drying unit 4 is adapted to dry the surface of the first catalyst layer 201 and the polymer electrolyte layer 301 which have been formed by simultaneous spreading.

Further, the coating compound supplying device 5 is adapted to supply the coating compound into the manifold 203 and is composed of a tank 501 for coating compound reserve, a coating compound supplying pump 502 and a three-way valve 503 which switches the supplying direction of coating compound.

The coating compound supplying device 7 has the same configuration as mentioned above and the coating compound supplying device 6 has the same configuration as the coating compound supplying devices 5, 7 except that no three-way valve is provided.

Further, the reference numeral 10 is a roll made of metal and a unit which continuously conveys the substrate 9.

Next, the operation of the apparatus of producing a membrane-electrode assembly according to the present embodiment will be described.

The apparatus of producing a membrane-electrode assembly used in the present embodiment comprises slits 202, 302 and manifolds 203, 303 provided in the nozzle 1, and coating compound supplying devices 5, 6 such that the first catalyst layer 201 and the polymer electrolyte layer 301 are simultaneously spread through the nozzle 1 and comprises a slit 402 and a manifold 403 provided in the nozzle 2, and a coating compound supplying device 7 such that the second catalyst layer 401 is spread over the first catalyst layer 201 and the polymer electrolyte layer 301 which has been simultaneously spread through the nozzle 2.

Here, at the same time with the suspension of the supply of the coating compound into the nozzle 1 by the switch of the three-way valve 503 at a constant interval of time, the sacbag device 3a which sucks the coating compound is operated to intermittently supply the coating compound while sucking the coating compound 11 from the interior of the nozzle 1 so that the first catalyst layer 201 is formed in a rectangular arrangement on the substrate 9.

Further, since the polymer electrolyte layer 301 is spread while the first catalyst layer 201 is wet, the polymer electrolyte layer 301 doesn't penetrate the interior of the first catalyst layer 201 to deteriorate the electrical properties.

Further, the second catalyst layer 401 is formed similarly to the first catalyst layer 201, i.e., by intermittently spreading the coating compound 13 as in the first catalyst layer 201 such that the outer edge thereof overlaps the rectangular shape of the first catalyst layer 201.

Further, the polymer electrolyte layer 301 is formed by supplying the coating compound 12 into the manifold 303 and the slit 302 through which it is then continuously spread in a band form.

During this procedure, supposing that the length of the substrate 9 in the running direction in the rectangular shape of the first catalyst layer 201 is L1 and the length of the substrate 9 in the running direction in the rectangular shape of the second catalyst layer 401 is L2, spreading is effected such that the condition L1≦L2 can be satisfied. In other words, spreading is effected in such a manner that the length of the rectangular shape of the second catalyst layer 401 in the running direction is not smaller than the length of the rectangular shape of the first catalyst layer 201 in the running direction.

While the present embodiment has been described with reference to the case where spreading is effected in such a manner that the width W1 of the first catalyst layer 201 and the width W2 of the second catalyst layer 401 satisfy the relationship W1≦W2 and, supposing that the length of the substrate 9 in the running direction in the rectangular shape of the first catalyst layer 201 is L1 and the length of the substrate 9 in the running direction in the rectangular shape of the second catalyst layer 401 is L2, the condition L1≦L2 can be satisfied, it suffices if the area of the second catalyst layer 401 in contact with the electrolyte layer 301 is merely larger than that of the first catalyst layer 201 in contact with the electrolyte layer 301.

The present embodiment is characterized in that the two-layer laminated material comprising the catalyst layer 201 and the electrolyte layer 301 is dried over the roll 10 by the drying unit 4 disposed between the nozzle 1 and the nozzle 2 such that the wet thickness thereof reaches a range of from 20 to 90% of the wet thickness of the two-laminated material which has been just formed as 100% and the second catalyst layer 401 is then spread over the two-laminated material to form a three-layer laminated material as a whole.

In other words, as the drying unit 4 there may be used, e.g., a hot air blower, infrared heater or the like. The drying temperature is preferably from 20° C. to 150° C. because when the drying temperature is less than 20° C., no drying effect can be exerted, and when the drying temperature is 150° C. or more, the first catalyst layer 201 is combusted. In the case of a hot air blower, the distance between the heat source of the drying unit 4 and the surface of the two-layer laminated material is preferably from not smaller than 10 mm to not greater than 500 mm because when it is less than 10 mm, the wind can disturb the surface of the coat layer, and when it is greater than 500 mm, heat is dissipated to the surrounding. Further, the flow rate of hot air at a point of 10 mm from the hot air outlet of the hot air blower is preferably from 1 m/s to 20 m/s.

In the case of infrared heater, the distance between the infrared heater and the coat layer is preferably from 10 mm to 1,000 mm because it is not necessary that the heat source come in contact with the surface of the two-layer laminated material and the heat source may be apart from the surface of the two-layer laminated material so far as the infrared ray can reach the surface of the two-layer laminated material.

While the present embodiment has been described with reference to the case where the first catalyst layer 201 is formed prior to the second catalyst layer 401, the present invention is not limited thereto, but the second catalyst layer 401 may be formed prior to the first catalyst layer 201. In other words, the formation of the hydrogen electrode may be followed by the formation of the oxygen electrode or the formation of the oxygen electrode may be followed by the formation of the hydrogen electrode.

Further, while the present embodiment has been described with reference to the case where the first catalyst layer 201 and the electrolyte layer 301 are simultaneously formed, the present invention is not limited thereto. The electrolyte layer 301 may be formed after the formation of the first catalyst layer 201 so far as it is effected while the first catalyst layer 201 is wet.

The nozzle 1 and the slit 202 of the present embodiment are according to an example of the first catalyst layer forming unit of the present invention, the nozzle 1 and the slit 302 of the present embodiment are according to an example of the electrolyte layer forming unit of the present invention, and the nozzle 2 and the slit 402 of the present embodiment are according to an example of the second catalyst layer forming unit of the present invention.

The advantages of the present Embodiment 1 will be generally described hereinafter.

Since the heat accumulated in the interior of the two-layer laminated material comprising the first catalyst layer 201 and the polymer electrolyte layer 301 during the drying of the two-layer laminated material over the roll 10 by the drying unit 4 disposed between the nozzle 1 and the nozzle 2 is transferred to the roll 10, only the surface of the electrolyte layer 301 is dried. Accordingly, the second catalyst layer 401 cannot penetrate the electrolyte layer 301, making it possible to form a definite interface having a remarkably high adhesive strength and obtain a membrane-electrode assembly which is not subject to cracking in the catalyst layer 301.

Further, since the first catalyst layer 201 is wet, the first catalyst layer 201 can be prevented from being deteriorated in electrical properties due to the penetration of the electrolyte layer 301 in the first catalyst layer 201.

Further, since it is arranged such that the area of the first catalyst layer 201 in contact with the electrolyte layer 301 is not greater than the area of the second catalyst layer 401 in contact with the electrolyte layer 301, the internal resistivity of the membrane-electrode assembly can be reduced.

Thus, the electricity-generating efficiency and the life properties of the fuel cell prepared from the membrane-electrode assembly of the present embodiment can be remarkably enhanced.

Thus, in accordance with the present embodiment, a method of producing a membrane-electrode assembly for fuel cell having an excellent surface flatness of various layers and a reduced dispersion of thickness can be provided.

### Embodiment 2

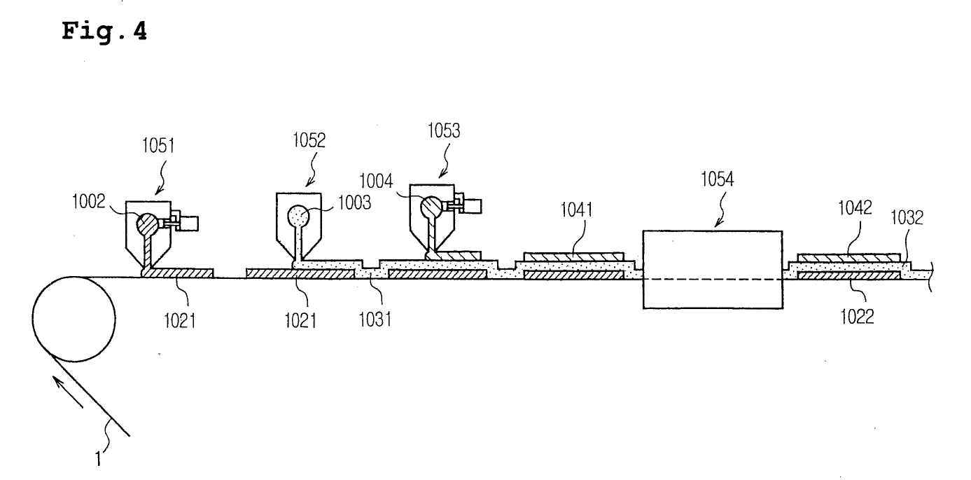

FIG. 4 is a typical process diagram illustrating an example of a method of producing MEA according to the present invention. In the example shown in FIG. 4, the band-shaped substrate 1001 is continuously conveyed and a catalyst coating compound 1002, a polymer electrolyte coating compound 1003 and a catalyst coating compound 1004 are sequentially spread over the substrate 1001. The spreading of the catalyst coating compound 1002, the polymer electrolyte coating compound 1003 and the catalyst coating compound 1004 are carried out by means of drying devices 1051, 1052 and 1053, respectively.

Further, in the example shown in FIG. 4, the polymer electrolyte layer 1003 is spread over the catalyst coating compound layer 1021 and the catalyst coating compound 1004 is spread over the polymer electrolyte layer 1031 before the drying of the polymer electrolyte coating compound layer 1031. The term “before drying” as used the present description is meant to indicate the state that the concentration of the polymer electrolyte in the polymer electrolyte coating compound layer 1031 is about 30% by weight or less. Thereafter, the various coating compound layers are dried by the drying device 1054, and when the substrate 1001 is then removed, MEA comprising a structure having the catalyst layer 1022, the polymer electrolyte layer 1032 and the catalyst layer 1042 laminated on each other can be obtained.

In accordance with the production method shown in the present embodiment, the various layers constituting MEA are formed by sequentially spreading the coating compounds over the substrate, eliminating the necessity of step of preparing the various layers separately or step of transferring or hot-pressing the various layers thus prepared. Therefore, the number of steps can be reduced, making it possible to further enhance the productivity of MEA.

Further, as compared with the case where the various layers which have been separately prepared are then subjected to transfer process or hot-pressing process to prepare MEA, the production method of the present embodiment provides an excellent adhesion between the catalyst layer and the polymer electrolyte layer constituting MEA, making it possible to inhibit separation or exfoliation at interfaces.

Further, since the catalyst coating compound 1004 is spread over the polymer electrolyte coating compound layer 1031 before the drying of the polymer electrolyte coating compound layer 1031, the occurrence of problems caused by the shortage of mechanical strength of the polymer electrolyte layer or the dissolution or swelling of the polymer electrolyte layer in the solvent contained in the catalyst coating compound as in the case where the catalyst coating compound is directly spread over the polymer electrolyte layer can be inhibited, making it possible to obtain MEA having little structural defects and stable electricity-generating properties.

Here, as the solvent for the catalyst coating compound 1004 to be spread over the polymer electrolyte coating compound layer 1031 there may be used a solvent containing an organic solvent having a boiling point of 120° C. or more at 1 atm in a proportion of 40% by weight or more. In this case, when the drying temperature used in 90% or more of the drying step described later falls within the range of from 60° C. to 80° C., MEA having little structural defects and stable electricity-generating properties can be obtained.

Further, as the solvent for the catalyst coating compound 1004 there may be also used a solvent containing an organic solvent having a saturated vapor pressure of −1.06 kPa (8 mmHg) or less at 20° C. in a proportion of 40% by weight or more. In particular, the solvent preferably contains an organic solvent having a saturated vapor pressure of 0.20 kPa (1.5 mmHg) or less at 20° C. In this case, when the drying temperature used in 90% or more of the drying step described later falls within the range of from 60° C. to 80° C., MEA having little structural defects and stable electricity-generating properties can be obtained.

By preparing the aforementioned catalyst coating compound 1004, the occurrence of crack on the surface of the catalyst layer which is an uppermost layer (catalyst layer formed on the polymer electrolyte layer) can be inhibited more than the related art simultaneous spreading method, making it possible to obtain MEA having little structural defects and stable electricity-generating properties. Therefore, the use of the aforementioned MEA makes it possible to obtain a fuel cell having higher discharge rate or life properties.

When the aforementioned catalyst coating compound 1004 is used, the drying rate of the catalyst coating compound layer 1041 is lower than ever. It is thus thought that the rate at which the surface of the catalyst coating compound layer 1041 is smoothened (leveled) due to the fluidity of the catalyst coating compound 1004 itself is great relative to the rate at which the catalyst coating compound layer 1041 is dried, making it possible to inhibit the occurrence of crack.

Not only the catalyst coating compound 1004 but also the polymer electrolyte coating compound 1003 and/or the catalyst coating compound 1002 to be spread over the substrate may contain said solvent. Further, the catalyst coating compound 1004 may be an anode catalyst coating compound or a cathode catalyst coating compound. However, when one of the catalyst coating compound 1004 and the catalyst coating compound 1002 is an anode catalyst coating compound, the other is a cathode catalyst coating compound.

Further, the aforementioned organic solvent preferably contains a compound represented by the following general formula (A):
R₁—O—(R₂O)ₙ—H (A)
wherein R₁ is one functional group selected from CH₃, C₂H₅, C₃H₇ and C₄H₉; R₂ is one functional group selected from C₂H₄ and C₃H₆; and n is one integer selected from 1, 2 and 3.

The polyvalent alcohol derivative represented by said general formula (A) is free of hydrolyzable functional group such as ester functional group and amide functional group and thus is excellent in stability in coating compound. Further, there can be exerted an effect of stabilizing the properties of coating compound particularly when the catalyst coating compound contains a material having a high acidity (binder).

As the organic solvent represented by said general formula (A) there may be used dipropylene glycol monomethyl ether, tripropylene glycol monomethyl ether, propylene glycol-n-propylene ether, dipropylene glycol-n-propyl ether, propylene glycol-n-butyl ether, dipropylene glycol-n-butyl ether, tripropylene glycol-n-butyl ether, etc., singly or in admixture.

Besides these solvents, propylene glycol diacetate, etc. may be used as the organic solvent having a saturated vapor pressure of 0.20 kPa (1.5 mmHg) or less at 20° C.

Further, the viscosity η₁ of the polymer electrolyte coating compound 1003 at a temperature of 25° C. and a shear rate of 1 s⁻¹ and the viscosity η₁₂ of the catalyst coating compound 1004 at a temperature of 25° C. and a shear rate of 1 s⁻¹ satisfy the relationship represented by the following expression:
1/25≦η₁/η₂≦25 (η₁>0, η₂>0) (1)

When the polymer electrolyte coating compound 1003 and the catalyst coating compound 1004 satisfy said relationship, the difference in viscosity between the polymer electrolyte coating compound 1003 and the catalyst coating compound 1004 in a low shearing rate range is reduced, making it possible to inhibit the occurrence of crack during the formation of the catalyst layer 1042 attributed to the fluidity of the polymer electrolyte coating compound layer 1031.

Further, it is particularly preferred that the relationship η₁>η₂ be satisfied. In this case, the fluidity of the polymer electrolyte coating compound layer 1031 is further reduced, making it possible to further enhance the effect of inhibiting the occurrence of crack during the formation of the catalyst layer 1042.

The spreading of the polymer electrolyte coating compound layer 1031 may be carried out batchwise. The spreading of the catalyst coating compound layer 1041, too, may be carried out batchwise so far as it is effected before the drying of the polymer electrolyte coating compound layer 1031. However, when the various coating compounds are sequentially spread over the band shaped substrate which is being continuously conveyed as shown in FIG. 4 in particular, the enhancement of productivity can be further realized.

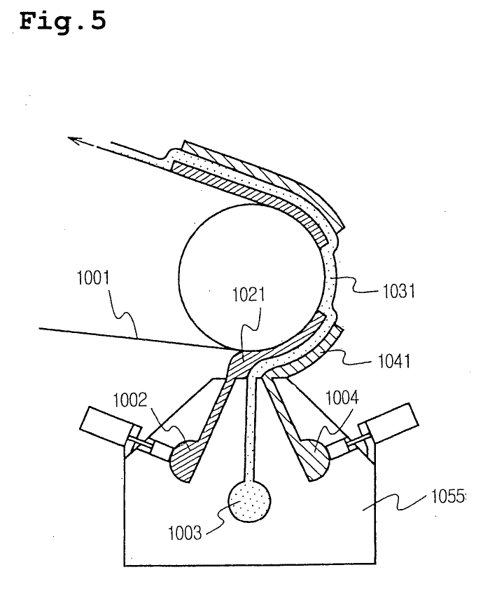

Further, it is not necessarily required that one coating device be used for each of the coating compounds as shown in FIG. 4, but a coating device capable of spreading a plurality of coating compounds may be used. An example of the coating device is shown in FIG. 5.

In the example shown in FIG. 5, the catalyst coating compound 1002, the polymer electrolyte coating compound 1003 and the catalyst coating compound 1004 are almost simultaneously and continuously spread over the substrate 1001 which is continuously conveyed by the coating device 1055 to laminate the catalyst coating compound layer 1021, the polymer electrolyte coating compound layer 1031 and the catalyst coating compound layer 1041 on the substrate 1001. During this procedure, the catalyst coating compound 1004 is spread over the polymer electrolyte coating compound layer 1031 before the drying of the polymer electrolyte coating compound layer 1031.

Next, the catalyst coating compound and the polymer electrolyte coating compound will be described.

As the polymer electrolyte coating compound there may be used any coating compound so far as it comprises a resin having hydrogenionic conductivity. As said resin there may be used, e.g., perfluoroethylenesulfonic acid-based resin, resin obtained by partial fluorination of ethylenesulfonic acid-based resin, hydrocarbon-based resin or the like. In particular, a perfluororesin such as perfluoroethylenesulfonic acid is preferably used.

Further, as the solvent to be used in the polymer electrolyte coating compound there may be used any solvent capable of dissolving said resin having hydrogenionic conductivity, but water, ethanol, 1-propanol or the like is preferably used from the standpoint of ease of spreading step and drying step. The content of the resin in the polymer electrolyte coating compound is preferably from 20% by weight to 30% by weight, particularly preferably from 22% by weight to 26% by weight. A polymer electrolyte layer having a proper porosity on the surface thereof can be obtained, and the resulting MEA can be provided with enhanced properties.

Further, the polymer electrolyte coating compound preferably contains a thickening agent. The incorporation of a thickening agent causes further reduction of the fluidity of the polymer electrolyte coating compound layer, further enhancing the effect of inhibiting the occurrence of crack during the formation of the catalyst layer on the polymer electrolyte layer.

The thickening agent is preferably incorporated in a proportion of 33% by weight or less based on the weight of the polymer electrolyte coating compound. When the proportion of the thickening agent falls within this range, the deterioration of hydrogenionic conductivity of the polymer electrolyte layer can be inhibited. As the thickening agent there may be used, e.g., ethyl cellulose, polyvinyl alcohol or the like. Further, it is particularly preferred that the thickening agent be incorporated in the polymer electrolyte coating compound in an amount of from 10% by weight to 33% by weight.

As the catalyst coating compound there may be used any coating compound so far as it comprises an electrically-conductive catalyst which causes said electrochemical reaction to proceed. In order to obtain a coating compound having good properties, said catalyst to be used is preferably in the form of powder. As said catalyst there may be used a carbon powder having a noble metal supported thereon.

In the case wherein the carbon powder having a noble metal supported thereon is used, platinum or the like may be used as the noble metal. In the case where an anode catalyst layer is formed after spreading and as the anode there is used a reforming gas containing CO or the like rather than pure hydrogen, the catalyst preferably further contains ruthenium or the like.

Further, as the carbon powder there may be used an electrically-conductive carbon black such as ketjen black and acetylene black. The average particle diameter of the carbon black is preferably from 100 nm to 500 nm.

As the solvent to be used in the catalyst coating compound there may be used solvents such as water, ethanol, methanol, isopropyl alcohol, ethylene glycol, methylene glycol, propylene glycol, methyl ethyl ketone, acetone, toluene and xylene, singly or in admixture. The added amount of the solvent is preferably from 10 parts by weight to 400 parts by weight based on 100 parts by weight of the carbon powder.

Further, the catalyst coating compound preferably contains a resin having hydrogenionic conductivity. A fluororesin is particularly preferred. As the fluororesin having hydrogenionic conductivity there may be used polyfluoroethylene, polyvinylidene fluoride, polyvinylidene fluoride-hexafluoropropylene copolymer, perfluoroethylenesulfonic acid, polyfluoroethylene-perfluoroethylenesulfonic acid copolymer, etc., singly or admixture of two or more thereof.

The catalyst coating compound may further comprise a binder, a dispersant, a thickening agent, etc. incorporated therein as necessary.

The solid content concentration of the catalyst compound is preferably adjusted to a range of from 7% by weight to 20% by weight, particularly preferably from 12% by weight to 17% by weight. The catalyst coating compound, too, can be prevented from being mixed with the various coating compound layers, making it possible to obtain a high quality MEA.

As the method of producing the catalyst coating compound there may be used, e.g., the following method.

Firstly, the catalyst and the solvent which is at least one component of the solvents to be used in the catalyst coating compound are kneaded with the solid content concentration kept high. This is a so-called “high solid concentration kneading (hard kneading)” step that makes it possible to adjust the dispersibility of the catalyst in the catalyst coating compound.

As the kneading machine to be used at said hard kneading step there may be used, e.g., planetary mixer or the like.

Subsequently, the mixture thus kneaded is diluted with the solvent which is at least one component of the solvents, and then further kneaded. Thereafter, dilution and kneading may be repeated as necessary until a catalyst coating compound having a necessary solid content concentration is finally obtained. The binder and the resin having hydrogenionic conductivity may be added at any necessary time so far as said hard kneading step has been finished.

In the case where as the catalyst there is used a carbon powder having a noble metal supported thereon, the resin having hydrogenionic conductivity may be previously attached to the carbon powder. In order to attach said resin to the carbon powder, a Henschel mixer or the like may be used.

As he kneader to be used during this step there may be used a spiral mixer, eirich mixer or the like besides said planetary mixer.

Preferably, there is incorporated a step of kneading the catalyst and the solvent which is at least one component of said solvents under the conditions that the proportion of the catalyst is 20% by weight or more. In particular, said hard kneading step is preferably effected under the conditions that the proportion of the catalyst is 20% by weight or more. Since kneading is effected at a high solid content concentration, the dispersibility of the catalyst in the catalyst coating compound can be enhanced, making it possible to reduce the viscosity of the catalyst coating compound in a low shearing rate range. Therefore, when the mixture thus kneaded is used as a catalyst coating compound (particularly as a catalyst coating compound to be spread over the polymer electrolyte layer), the fluidity of the catalyst coating compound layer thus spread can be raised, making it possible to further inhibit the occurrence of crack during the formation of the catalyst layer.

Further, at said step of kneading under the conditions that the proportion of the catalyst is 20% by weight or more, the solvent to be kneaded with the catalyst is preferably a solvent having the highest affinity for said catalyst among said solvent components. The term “solvent having the highest affinity” as used herein is meant to indicate a solvent capable of best dispersing said catalyst.

As the substrate there may be used a resin film made of polyethyleneterephthalate (PET), polypropylene (PP), polyethylene (PE), polycarbonate (PC) or the like or one obtained by subjecting such a resin film to surface treatment. Alternatively, a gas-permeable collector may be used. The thickness of the substrate is preferably from 50 μm to 150 μm.

As the coating device there may be used, e.g., die coater, gravure coater, reverse coater or the like. The thickness of the polymer electrolyte coating compound layer thus spread is preferably from 10 μm to 30 μm and the thickness of the catalyst coating compound layer thus spread is preferably from 3 μm to 100 μm.

Further, as the method of spreading there may be used a method disclosed in Japanese Patent No. 2,842,347, Japanese Patent No. 3,162,026, etc.

The various coating compound layers laminated on the substrate 1001 shown in FIG. 4 are dried by the drying device 1054 to form MEA having a structure comprising a catalyst layer and a polymer electrolyte layer laminated on each other. Here, the as the drying process there may be used a hot air process, infrared ray process or the like. The drying temperature may vary with the solvent component used in the various coating compounds but is preferably from 60° C. to 80° C.

If necessary, a plurality of drying devices having different temperatures may be provided or the drying device may be omitted.

FIG. 6 is a typical diagram illustrating an example of MEA prepared by a method of producing MEA according to the present invention. A catalyst layer 1022, a polymer electrolyte layer 1032 and a catalyst layer 1042 are laminated on a band-shaped substrate 1001. In the example shown in FIG. 6, the laminate is not yet worked into a shape adapted for assembly of actual cell and thus requires the removal of the substrate and shaping later. Here, the width W₁ of the catalyst layer 1022, the width W₂ of the polymer electrolyte layer 1032 and the width W₃ of the catalyst layer 1042 preferably satisfy the relationships W₁≦W₂ and W₃≦W₂. The width of the various layers can be adjusted during the spreading of the various coating compounds.

Further, when the coating compounds are spread such that the outer edge of the catalyst layer 1022 and the catalyst layer 1042 overlap almost each other, the loss of the catalyst layer containing an expensive noble metal can be minimized by conforming the shape of punching or other working subsequently effected to that of the laminate, making it possible to reduce the production cost of the fuel cell.

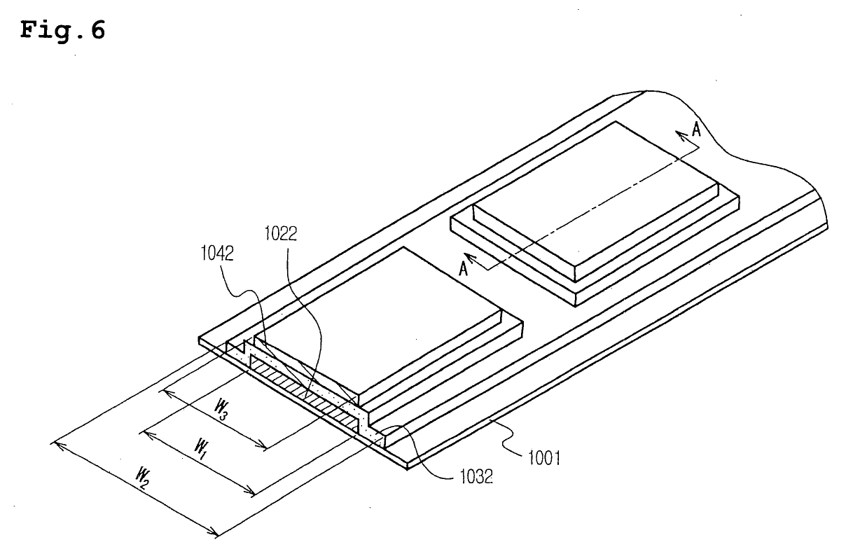

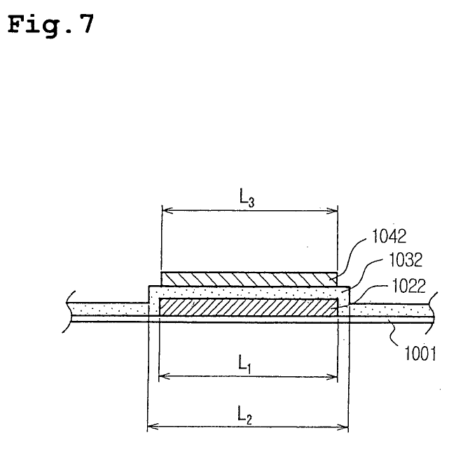

FIG. 7 illustrates a sectional view taken in the line A-A of MEA shown in FIG. 6. The length L₁ of the catalyst layer 1022 in the conveying direction of the substrate 1001, the length L₂ of the catalyst layer 1032 in the conveying direction of the substrate 1001 and the length L₃ of the catalyst layer 1042 in the conveying direction of the substrate 1001 preferably satisfy the relationships L₁≦L₂ and L₃≦L₂. The catalyst layer 1022 and the catalyst layer 1042 can be made difficult to come in contact with each other after lamination, making it possible to inhibit the occurrence of leakage in the resulting MEA. The length of the various layers can be adjusted during the spreading of the various coating compounds.

Further, as shown in FIGS. 6 and 7, the polymer electrolyte layer 1032 preferably covers the catalyst layer 1022. MEA which is less or inhibits occurrence of leakage can be obtained. This shape can be obtained by adjusting the spreading time of the various coating compounds.

While the polymer electrolyte layer 1032 is continuously formed in a band form in the example shown in FIG. 6, the polymer electrolyte layer 1032 may be intermittently formed similarly to the catalyst layer 1022 or the catalyst layer 1042. During this procedure, the various layers may be formed in a shape allowing the actual cell to generate electricity. Further, by adjusting the spreading time of the various coating compounds, MEA can be previously formed in a shape for assembly to cell, and in this case, the step of shaping can be omitted.

Further, an interlayer may be formed between the catalyst layer 1022 and the polymer electrolyte layer 1032 and/or between the catalyst layer 1042 and the polymer electrolyte layer 1032 by the change of the formulation of the coating compounds or the like. The adhesion between layers can be enhanced to further enhance the adhesive strength on the interface of the various layers constituting MEA, making it possible to obtain MEA having better properties and a high reliability. When MEA having excellent properties and a high reliability is assembled into a cell, a fuel cell having a higher discharge rate and better life properties can be obtained.

### Embodiment 3

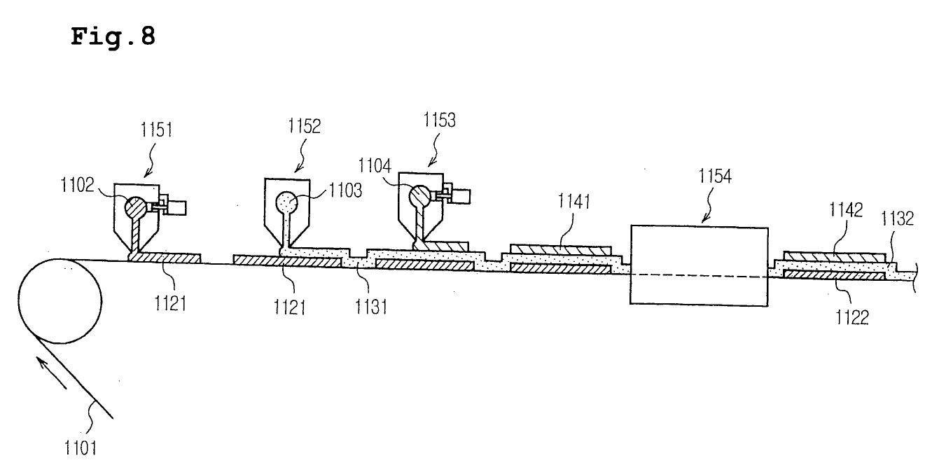

FIG. 8 is a typical process diagram illustrating an example of a method of producing MEA according to the present invention. In the example shown in FIG. 8, a band-shaped substrate 1101 is continuously conveyed and a catalyst coating compound 1102, a polymer electrolyte coating compound 1103 and a catalyst coating compound 1104 are sequentially spread over the substrate 1101. The spreading of the catalyst coating compound 1102, the polymer electrolyte coating compound 1103 and the catalyst coating compound 1104 are carried out by a coating devices 1151, 1152 and 1153, respectively.

The various coating compounds thus spread become catalyst coating compound layers 1121 and 1141 and a polymer electrolyte coating compound layer 1131, respectively, and when these layers are dried by a drying device 1154 and the substrate 1101 is then removed, MEA having a catalyst layer 1122, a polymer electrolyte layer 1132 and a catalyst layer 1142 laminated on each other can be obtained.

Here, the polymer electrolyte coating compound 1103 preferably contains a gelatinizing agent. The incorporation of the gelatinizing agent makes it possible to suppress the fluidity of the polymer electrolyte coating compound layer 1131 and hence inhibit further the occurrence of crack during the formation of the catalyst layer 1142.

The gelatinizing agent is preferably incorporated in an amount of 33% by weight or less based on the polymer electrolyte coating compound. Within this range, the deterioration of the hydrogenionic conductivity of the polymer electrolyte layer can be inhibited. Further, the proportion of the gelatinizing agent is preferably from 5% by weight to 33% by weight.

The gelatinizing agent is preferably a temperature sensitive gelatinizing agent. A temperature-sensitive gelatinizing agent is a material which acts as a gelatinizing agent at a temperature of not lower than a predetermined value. Therefore, when a temperature-sensitive gelatinizing agent which begins to act as a gelatinizing agent within a range where drying is effected is used, the fluidity of the polymer electrolyte coating compound 1103 can be kept during the spreading thereof (that is, coating can be easily conducted), making it possible to suppress the fluidity of the polymer electrolyte coating compound layer 1131 during the heat drying which is considered to cause cracking in the catalyst layer 1142.

As the temperature-sensitive gelatinizing agent there may be used, e.g., styrene-butadiene rubber-based gelatinizing agent having a gelatinizing temperature-sensitive gelatinizing agent of from 40° C. to 70° C.

In the case where the polymer electrolyte coating compound contains a gelatinizing agent, the polymer electrolyte layer of MEA obtained by spreading and drying thereof has porous properties. The average pore diameter differs with the material of the polymer electrolyte coating compound, gelatinizing agent used, etc., but since the pores have a diameter of from about 0.1 μm to 1.0 μm and are closed, the occurrence of gas leak or the like can be inhibited.

The polymer electrolyte coating compound 1103 may further contain said thickening agent. In this case, the thickening agent is preferably incorporated in an amount of 10% by weight or less based on the polymer electrolyte coating compound.

Further, in the example shown in FIG. 8, the catalyst coating compound layer 1141 is spread before the drying of the polymer electrolyte coating compound layer 1131 as in the example shown in FIG. 4, but when the polymer electrolyte coating compound contains a gelatinizing agent, the catalyst coating compound may be spread over the polymer electrolyte layer obtained by drying the polymer electrolyte coating compound layer.

As mentioned above, in the case where the catalyst coating compound has heretofore been directly spread over the polymer electrolyte layer (i.e., identical to polymer electrolyte membrane), it was disadvantageous in that the mechanical strength of the polymer electrolyte membrane is normally small or the polymer electrolyte membrane is dissolved in or swells with the solvent component contained in the catalyst coating compound.

However, when the polymer electrolyte coating compound contains a gelatinizing agent, the polymer electrolyte layer obtained by drying the polymer electrolyte coating compound can be provided with an enhanced strength and can be prevented from being dissolved in or swelling with the solvent component contained in the catalyst coating compound. Therefore, MEA having excellent properties and a high reliability can be obtained. Further, the variation of the method of producing MEA can be increased while keeping the properties and reliability of MEA, e.g., by spreading a catalyst coating compound over the both surfaces of the polymer electrolyte layer which has been previously formed.

In the example shown in FIG. 8, as the base, catalyst coating compound, coating device, drying device, etc. besides the polymer electrolyte coating compound 1103 there may be used the same ones as used in Embodiment 2.

### Embodiment 4

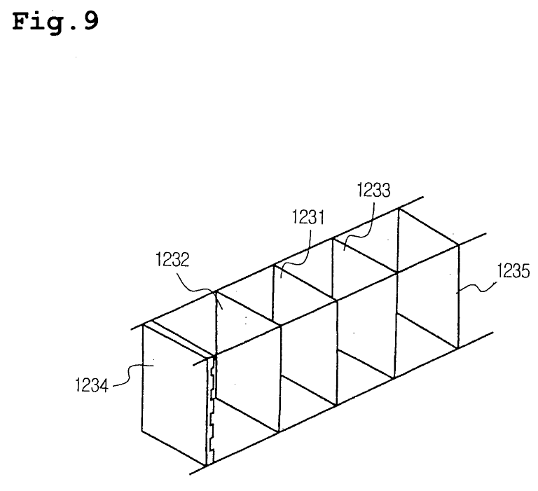

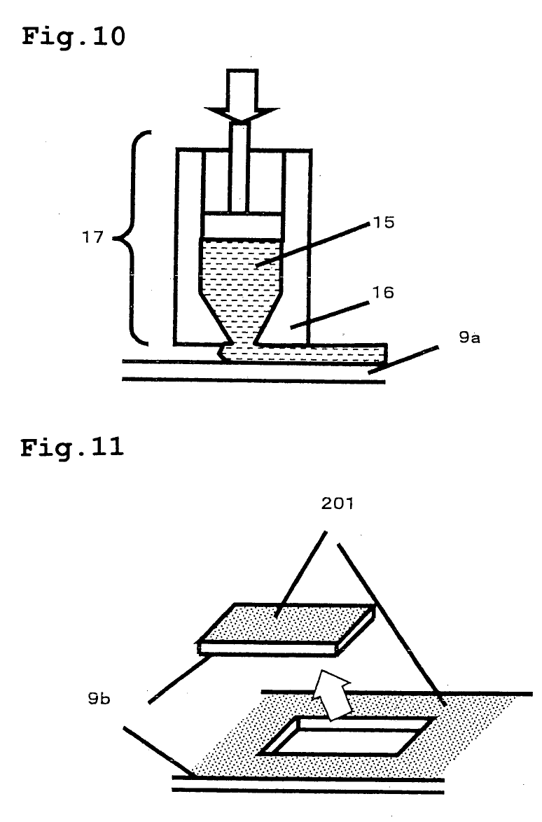

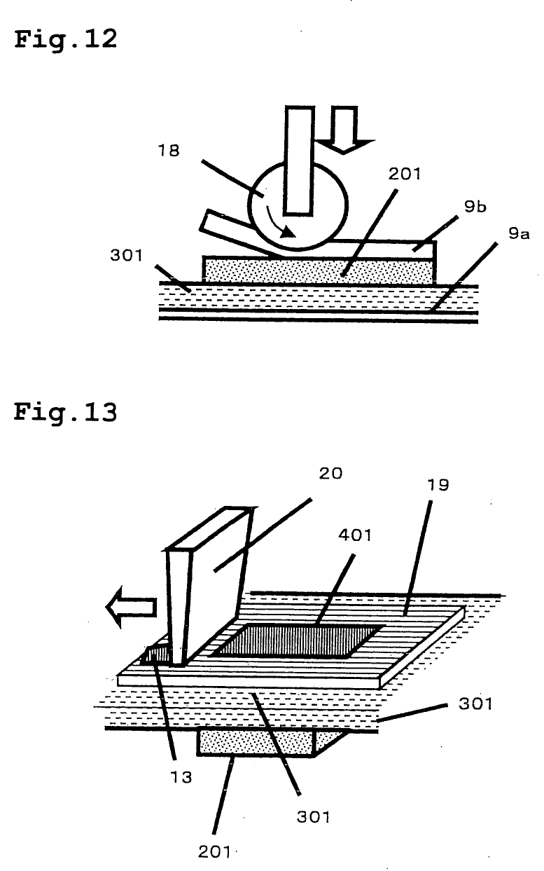

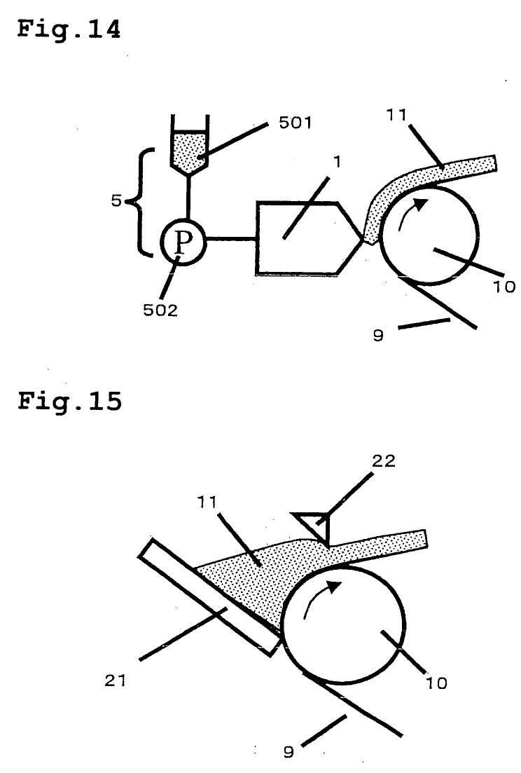

FIG. 9 is a typical diagram illustrating an example of the configuration of a single unit of fuel cell according to the present invention, and the single cell having the structure shown in FIG. 9 can be obtained by a method of producing an ordinary fuel cell.

For example, gas diffusion layers 1232 and 1233 are disposed on the respective side of MEA 1231 obtained in said embodiment. Subsequently, a gasket for preventing the entrance of cooling water or the leakage of reactive gas is disposed on MEA 1231 and manifold holes for cooling water and reactive gas are formed. Thereafter, separators 1234 and 1235 having a reactive gas flow path formed on the surface thereof are disposed such that said flow paths come in contact with the gas diffusion layers 1232 and 1233, respectively, and the whole components are then bonded to each other to obtain a single unit of fuel cell. One of the separators 1234 and 1235 is an anode separator and the other is a cathode separator. Further, when a plurality of the single cells thus obtained are laminated, a stack of fuel cells can be obtained.

As the gas diffusion layer there may be used one having electrical conductivity and permeability to reactive gas. For example, a carbon paper, carbon cloth, etc. may be used. If necessary, the gas diffusion layer may be subjected to water repellent treatment with a polytetrafluoroethylene or the like.

The gasket may be made of rubber, silicon or the like.

As the separator there may be used any material so far as it has electrical conductivity and necessary mechanical strength. For example, a graphite plate impregnated with a phenolic resin, an expanded graphite, a metal plate which is subjected to oxidation resistant treatment on the surface thereof or the like may be used.

The present invention will be further described hereinafter in the following examples.

### EXAMPLE 1

In the present example, samples comprising organic solvents set forth in Table 1 as solvent for catalyst coating compound were prepared (9 kinds) to prepare respective MEA's which were each then evaluated for properties. Among said organic solvents, ethanol has heretofore been used.

To 100 g of a carbon powder having platinum supported thereon in an amount of 50% by weight (TEC10E50E, produced by Tanaka Kikinzoku Group, Inc.) was added 233 g of ion-exchanged water. Using a planetary mixer type kneading machine having a capacity of 20 L (HIVIS MIX, produced by TOKUSHU KIKA KOGYO CO., LTD.), the powder was then subjected to hard kneading which was a first kneading step in the process for the production of catalyst coating compound. The hard kneading was effected at a planetary blade rotary speed of 40 rpm for 90 minutes under the condition that the solid content concentration was 30% by weight.

Subsequently, 23 g of organic solvents set forth in Table 1 and 55 g of 1-propanol were each equally divided into two portions which were then batchwise charged into the kneading machine. After each charging, the mixture was kneaded at a planetary blade rotary speed of 50 rpm for 10 minutes. After the second addition, the solid content concentration reached 24.3% by weight.

Subsequently, 197 g of a polymer electrolyte dispersion (23.5 wt-% dispersion of perfluoroethylene sulfonic acid) as a polymer electrolyte coating compound were equally divided into four portions which were then batchwise charged into the kneading machine. After each charging, the mixture was kneaded at a planetary blade rotary speed of 50 rpm for 10 minutes. The dispersant for the polymer electrolyte dispersion was a mixture of water, ethanol and 1-propanol, and their mixing proportions were 22% by weight, 18% by weight and 60% by weight, respectively.

Subsequently, 353 g of organic solvents set forth in Table 1 were each equally divided into three portions which were then charged into the kneading machine. After each charging, the mixture was kneaded at a planetary blade rotary speed of 50 rpm for 10 minutes until the solid content concentration reached 15% by weight.

Thereafter, 3 g of water and 174 g of organic solvents set forth in Table 1 were each equally divided into two portions which were then charged into the kneading machine. After each charging, the mixture was kneaded at a planetary blade rotary speed of 50 rpm for 10 minutes. Thus, a cathode catalyst coating compound having a solid content concentration of 12% by weight (weight ratio of said organic solvent in the solvent was 60% by weight) was prepared.

Further, an anode catalyst coating compound was prepared in the same manner as described above except that as the organic solvent there was used ethanol instead of the organic solvents set forth in Table 1 and as the catalyst there was used a carbon powder having 30 wt-% of platinum and 15 wt-% of ruthenium supported on ketjen black (45% by weight).

Using a die coater, said polymer electrolyte dispersion (23.5 wt-% dispersion of perfluoroethylene sulfonic acid) and the cathode catalyst coating compound and anode catalyst coating compound prepared above were then spread over a substrate made of polyethylene terephthalate which had been subjected to release treatment (Cellapeel SW, produced by TOYO METALLIZING CO., LTD.; thickness: 50 μm) in such a manner that an anode catalyst coating compound layer (thickness: 15 μm), a polymer electrolyte coating compound layer (thickness: 30 μm) and a cathode catalyst coating compound layer (thickness: 20 μm) were sequentially formed on the substrate. The interval of time between the spreading of the various coating compounds, i.e., time required until the subsequent coating compound is spread over any of the coating compounds spread was 5 seconds.

During this procedure, the polymer electrolyte coating compound layer was continuously spread with a width (corresponding to W2 in FIG. 6) of 130 mm and the both catalyst coating compound layers were each intermittently spread in a rectangular shape of 70 mm×70 mm as viewed in the direction of lamination. The anode catalyst coating compound layer and the cathode catalyst coating compound layer were spread in such a manner that the outer edge thereof overlapped almost each other as viewed in the direction of lamination, and the interval of intermittent spreading of the catalyst coating compound layers was 65 mm. The running speed of the substrate during spreading was 1.5 m/min.

Thereafter, the laminate was dried by a counterflow hot air process for 2 minutes to obtain MEA laminated on the substrate. During this procedure, arrangement was made such that the surface temperature of the coat layer reached 80° C. and the speed of hot air on the surface of the coat layer reached 3.0 m/s.

The occurrence of crack on the surface of the cathode catalyst layer which is an uppermost layer thus obtained was subjected to image evaluation by binarization to evaluate the percent occupation of cracked portion. The percent crack occupation of the various samples relative to that of the sample comprising ethanol as 100 are set forth in Table 1 below.

MEA thus obtained was slit, dipped in a 100° C. ion-exchanged water for 1 hour, and then hot-air dried at 80° C. for 30 minutes to remove residual solvent. Using MEA thus obtained, electricity generation was actually conducted, and the electricity-generating properties thereof were evaluated.

Firstly, MEA laminated on the substrate was slit at the portion where only the polymer electrolyte layer is laminated so that the portion was removed, and the substrate was then removed from the laminate to obtain an MEA sample having a size of 120 mm×120 mm.

Separately, a gas diffusion layer was prepared as follows. Acetylene black and an aqueous dispersion of polytetrafluoroethylene were mixed to prepare a water-repellent in containing a polytetrafluoroethylene in an amount of 20% by weight as calculated in terms of dried weight. The water-repellent ink was spread over a carbon paper which is an aggregate for gas diffusion layer so that the carbon paper was impregnated with the ink, and the carbon paper was then subjected to heat treatment at 300° C. using a hot air drier to form a water-repellent gas diffusion layer.

Said gas diffusion layer was stuck to said MEA in such an arrangement that it came in contact with the surface of the both catalyst layers of MEA to prepare an electrode to the circumference of which a rubber gasket plate was then bonded, and manifold holes for the passage of cooling water and reactive gas were then formed thereon.

Further, two sheets of separator made of graphite plate impregnated with a phenolic resin (one having a fuel gas flow path formed therein and the other having an oxidizing gas flow path formed therein) were prepared, and these separators and said electrode were then laminated on and bonded to each other in contact with each other (such that the fuel gas flow path and the anode electrode come in contact with each other and the oxidizing agent gas flow path and the cathode electrode come in contact with each other) to prepare a single cell having the configuration shown in FIG. 9.

After the preparation of the single cell, pure hydrogen gas and air were supplied into the fuel electrode and the oxidation electrode, respectively, to make electricity-generation test on said single cell. Thus, the initial discharge voltage at a current density of 0.2 A/cm² in the initial stage of electricity generation and the discharge voltage at a point of 1,000 hours after the initiation of electricity generation were measured. During this procedure, the cell temperature-sensitive gelatinizing agent was 75° C., the percent fuel gas utilization U_{f} was 70%, the percent oxidizing gas utilization Uo was 40%, the dew point of fuel gas was 70° C., and the dew point of oxidizing gas was 50° C.

The results of electricity-generation test on said single cell are set forth in Table 1. In the case where ethanol was used as an organic solvent, violet cracking occurred on the surface of the cathode catalyst layer, making it difficult to prepare a single cell. Therefore, the results of electricity-generation test are represented relative to that of the sample comprising propylene glycol monomethyl ether as an organic solvent (initial discharge voltage: 0.74 V; discharge voltage after the lapse of 1,000 hours: 0.72 V) as 100.

TABLE 1

| | | | Percent | Initial | Discharge |
|---|---|---|---|---|---|
| | | | occupation | discharge | voltage after |
| | Boiling | Saturated vapor | of crack on | voltage | 5,000 hours |
| | point | pressure at 20° C. | catalyst layer | (relative value) | (relative value) |
| Name of solvent | (° C.) | (mmHg) | (%) | (%) | (%) |
| Ethanol (related art) | 78 | 45 | — | — | — |
| Propylene glycol | 121 | 8 | 70 | 100 | 100 |
| monomethyl ether | | | | | |
| Dipropylene glycol | 189 | <0.1 | 60 | 103 | 101 |
| monomethyl ether | | | | | |
| Tripropylene glycol | 243 | 0.02 | 10 | 110 | 109 |
| monomethyl ether | | | | | |
| Propylene | 150 | 1.5 | 50 | 104 | 105 |
| glycol-n-propyl ether | | | | | |
| Dipropylene | 212 | 0.08 | 10 | 110 | 111 |
| glycol-n-propyl ether | | | | | |
| Propylene | 170 | 0.85 | 10 | 109 | 110 |
| glycol-n-butyl ether | | | | | |
| Dipropylene | 229 | 0.04 | 10 | 111 | 109 |
| glycol-n-butyl ether | | | | | |
| Propylene glycol | 190 | <0.1 | 75 | 98 | 97 |
| diacetate | | | | | |

As can be seen in Table 1, in the case where as the solvent for the catalyst coating compound there was used a solvent an organic solvent having a boiling point of 120° C. or more at 1 atm (in an amount 60% by weight in the present example), the percent occupation of crack on the cathode catalyst layer laminated on the polymer electrolyte layer was reduced. Further, electricity generation was made without any problem as opposed to the related art example comprising ethanol in which a single cell was difficultly prepared.

It can be also seen that in the case where as the solvent for the catalyst coating compound there was used a solvent containing an organic solvent having a saturated vapor pressure of 1.06 kPa (8 mmHg) or less at 20° C. (in an amount of 60% by weight in the present example), the percent occupation of crack on the cathode catalyst layer laminated on the polymer electrolyte layer was reduced.

In particular, it can be seen that in the case where the solvent for the catalyst coating compound contains an organic solvent having a saturated vapor pressure of 0.20 kPa (1.5 mmHg) or less at 20° C. (in an amount of 60% by weight in the present example), when the organic solvent is represented by said general formula (A), cell properties such as discharge rate and life are particularly improved.

### EXAMPLE 2

In the present example, a test was made using the same manner as in Example 1 to change the weight proportion of said organic solvent in the cathode catalyst coating compound. As said organic solvent there was used propylene glycol-n-butyl ether.

Firstly, a cathode catalyst coating compound comprising said organic solvent incorporated therein in an amount of 40% by weight was prepared in the following manner.

To 100 g of a carbon powder having platinum supported thereon in an amount of 50% by weight (TEC10E50E, produced by Tanaka Kikinzoku Group, Inc.) was added 233 g of ion-exchanged water. Using a planetary mixer type kneading machine having a capacity of 20 L (HIVIS MIX, produced by TOKUSHU KIKA KOGYO CO., LTD.), the powder was then subjected to hard kneading which was a first kneading step in the process for the production of catalyst coating compound. The hard kneading was effected at a planetary blade rotary speed of 40 rpm for 90 minutes under the condition that the solid content concentration was 30% by weight.

Subsequently, 23 g of propylene glycol-n-butyl ether and 55 g of 1-propanol were each equally divided into two portions which were then batchwise charged into the kneading machine. After each charging, the mixture was kneaded at a planetary blade rotary speed of 50 rpm for 10 minutes.

Subsequently, 197 g of a polymer electrolyte dispersion (23.5 wt-% dispersion of perfluoroethylene sulfonic acid) were equally divided into four portions which were then batchwise charged into the kneading machine. After each charging, the mixture was kneaded at a planetary blade rotary speed of 50 rpm for 10 minutes. The dispersant for the polymer electrolyte dispersion was a mixture of water, ethanol and 1-propanol, and their mixing proportions were 22% by weight, 18% by weight and 60% by weight, respectively.

Subsequently, 235 g of propylene-n-butyl ether was equally divided into two portions where were then batchwise charged into the kneading machine. After each charging, the mixture was kneaded at a planetary blade rotary speed of 50 rpm for 10 minutes. Further, 89 g of propylene glycol-n-butyl ether was charged into the kneading machine, and then kneaded at a planetary blade rotary speed of 50 rpm for 10 minutes.

Thereafter, 205 g of water and 82 g of propylene glycol-n-butyl ether were each equally divided into two portions which were then batchwise charged into the kneading machine. After each charging, the mixture was kneaded at a planetary blade rotary speed of 50 rpm for 10 minutes. Thus, a cathode catalyst coating compound having a solid content concentration of 12% by weight (weight ratio of said organic solvent in the solvent was 40% by weight) was prepared.

Subsequently, a cathode catalyst coating compound comprising said organic solvent incorporated therein in an amount of 30% by weight was prepared in the following manner.

After charging of the polymer electrolyte dispersion, the same procedure as described above was effected until kneading by a planetary blade. Thereafter, 118 g of propylene glycol-n-butyl ether was charged into the kneading machine. The mixture was then kneaded at a planetary blade rotary speed of 50 rpm for 10 minutes.

Thereafter, 107 g of propyleneglycol-n-butyl ether was charged into the kneading machine. The mixture was then kneaded at a planetary blade rotary speed of 50 rpm for 10 minutes. Subsequently, 312 g of water and 74 g of propylene glycol-n-butyl ether were each equally divided into two portions which were then charged into the kneading machine. After each charging, the mixture was kneaded at a planetary blade rotary speed of 50 rpm for 10 minutes. Thus, a cathode catalyst coating compound having a solid content concentration of 12% by weight (weight ratio of said organic solvent in the solvent was 30% by weight) was prepared.

Subsequently, a cathode catalyst coating compound comprising said organic solvent incorporated therein in an amount of 35% by weight was prepared in the following manner.

After charging of the polymer electrolyte dispersion, the same procedure as described above was effected until kneading by a planetary blade. Thereafter, 235 g of propylene glycol-n-butyl ether was equally divided into two portions which were then charged into the kneading machine. After each charging, the mixture was then kneaded at a planetary blade rotary speed of 50 rpm for 10 minutes.

Thereafter, 259 g of water and 118 g of propylene glycol-n-butyl ether were each equally divided into two portions which were then batchwise charged into the kneading machine. After each charging, the mixture was kneaded at a planetary blade rotary speed of 50 rpm for 10 minutes. Thus, a cathode catalyst coating compound having a solid content concentration of 12% by weight (weight ratio of said organic solvent in the solvent was 35% by weight) was prepared.

The percent occupation of crack on the cathode catalyst layer during the preparation of MEA from the cathode catalyst coating compound thus prepared in the same manner as in Example 1 and the cell properties of a single cell prepared from MEA thus obtained were evaluated. The results of the evaluation of said properties are set forth in Table 2 together with the results of Example 1 (weight proportion of propylene glycol-butyl ether in the solvent: 60% by weight).

TABLE 2

| Proportion | Percent occupation | Initial discharge | Discharge voltage |
|---|---|---|---|
| of organic | of crack in | voltage | after 5000 hours |
| solvent | catalyst layer | (relative value) | (relative value) |
| (%) | (%) | (%) | (%) |
| 60 | 10 | 109 | 110 |
| 40 | 50 | 105 | 105 |
| 35 | 75 | 99 | 99 |
| 30 | 80 | 98 | 97 |

As can be seen in Table 2, in the case where as the solvent for the catalyst coating compound there was used a solvent containing an organic solvent having a saturated vapor pressure of 1.06 kPa (8 mmHg) or less at 20° C. (propylene glycol-n-butyl ether) in an amount of 40% by weight, the percent occupation of crack on the cathode catalyst layer laminated on the polymer electrolyte layer was improved, demonstrating that the cell properties were

### EXAMPLE 3

Cathode catalyst coating compounds comprising a solvent containing propylene glycol-n-butyl ether in an amount of 40% by weight as a catalyst coating compound solvent were prepared in the same manner as in Example 2 except that the solid content concentration at the hard kneading step which is a first kneading step in the process for the production of catalyst coating compound were 20% by weight and 17% by weight, respectively. The cathode catalyst coating compounds were then evaluated in the same manner as in Example 1.

The cathode catalyst coating compound having a solid content concentration of 20% by weight was prepared by adding 400 g of ion-exchanged water to 100 g of a carbon powder having platinum supported thereon in an amount of 50% by weight (TEC10E50E, produced by Tanaka Kikinzoku Group, Inc.) during hard kneading. The other steps were the same as in the method of producing a cathode catalyst coating compound comprising propylene glycol-n-butyl ether in the solvent in a proportion of 40% by weight in Example 2. However, at the last charging in the method described in Example 2, the step of “equally dividing 312 g of water and 84 g of propylene glycol-n-butyl ether into two portions which are then charged into the kneading machine” was changed to the step of “equally dividing 54 g of water and 93 g of propylene glycol-n-butyl ether into two portions which are then charged into the kneading machine”.

The cathode catalyst coating compound having a solid content concentration of 17% by weight was prepared similarly by adding 488 g of ion-exchanged water to 100 g of a carbon powder having platinum supported thereon in an amount of 50% by weight (TEC10E50E, produced by Tanaka Kikinzoku Group, Inc.) during hard kneading. In this method described in Example 2, too, at the last charging, the step of “equally dividing 312 g of water and 84 g of propylene glycol-n-butyl ether into two portions which are then charged into the kneading machine” was changed to the step of “equally dividing 59 g of propylene glycol-n-butyl ether into two portions which are then charged into the kneading machine”.

The percent occupation of crack on the cathode catalyst layer during the preparation of MEA from the cathode catalyst coating compound thus prepared in the same manner as in Example 1 and the cell properties of a single cell prepared from MEA thus obtained were evaluated. The results of the evaluation of said properties are set forth in Table 3 together with the results of Example 2 (solid content concentration during hard kneading: 30% by weight).

Further, the cathode catalyst coating compounds thus prepared were each measured for shearing viscosity from which the ratio to the shearing viscosity of the polymer electrolyte coating compound to be used in the present example (23.5% dispersion of perfluoroethylene sulfonic acid) was then determined. The shearing viscosity was measured at a temperature of 25° C. and a shear rate of 1 s⁻¹ by a cone-plate type viscometer (RFSII, produced by Rheometric Scientific F.E. Ltd.). The shearing viscosity of said polymer electrolyte coating compound was 0.7 Pas.

Said shearing viscosity ratio is represented by a value obtained by comparing the measurements of shearing viscosity of the cathode catalyst coating compound and the polymer electrolyte coating compound, and then diving the greater value by the smaller value (hereinafter referred to as “Value B”). In the present example, all the cathode catalyst coating compounds showed a greater shearing viscosity than the other.

The value B of the various cathode catalyst coating compounds thus determined are altogether set forth in Table 3.

TABLE 3

| | | Percent | Initial | Discharge |
|---|---|---|---|---|
| | | occupation | discharge | voltage after |
| Solid content | | of crack on | voltage | 5,000 hours |
| concentration | | catalyst layer | (relative value) | (relative value) |
| (%) | Value B | (%) | (%) | (%) |
| 30 | 21 | 50 | 105 | 105 |
| 20 | 25 | 52 | 104 | 104 |
| 17 | 40 | 65 | 100 | 100 |

As can be seen in Table 3, MEA comprising a cathode catalyst coating compound prepared by hard kneading under the conditions that the solid content concentration is 20% by weight or more showed less occurrence of crack on the cathode catalyst layer and better cell properties. It is thought that the greater the solid content concentration during hard kneading is, the higher is the dispersibility of catalyst and the less is the viscosity of the catalyst coating compound at a low shear rate, demonstrating that the ratio of viscosity to the polymer electrolyte coating compound is reduced. As shown in Table 3, in the case where the value B, which represents the viscosity ratio of the catalyst coating compound and the polymer electrolyte coating compound, is 25 or less, the occurrence of crack on the cathode catalyst layer is inhibited, enhancing the cell properties.

### EXAMPLE 4

In the present example, in order to further study said value B, a test on the change of the viscosity of the polymer electrolyte coating compound by the addition of a thickening agent to the polymer electrolyte coating compound was effected.

Four polymer electrolyte coating compounds comprising as a thickening agent a polyvinyl alcohol having a polymerization degree of 2,000 in an amount of 5% by weight and 7% by weight and a polyvinyl alcohol having a polymerization degree of 200 in an amount of 10% by weight and 13% by weight, respectively, were prepared. The base of the polymer electrolyte coating compounds was a 23.5% dispersion of perfluoroethylene sulfonic acid as used in said example. The saponification degree of the polyvinyl alcohols were all from 98.0 mol-% to 99.0 mol-%.

As the cathode catalyst coating compound there was used a catalyst coating compound containing a propylene glycol-n-butyl ether as a solvent in an amount of 40% by weight as used in Example 1. The percent occupation of crack on the cathode catalyst layer during the preparation of MEA, the properties of single cell assembled by MEA and the value B were then evaluated in the same manner as in Example 3. The results are set forth in Table 4 together with the results of the case where no thickening agent is incorporated. In Table 4, the sign “+” of the value B indicates that the shearing viscosity of the cathode catalyst coating compound is greater than that of the polymer electrolyte coating compound and the sign “−” of the value B indicates that the shearing viscosity of the cathode catalyst coating compound is smaller than that of the polymer electrolyte coating compound.

TABLE 4

| | | | Percent | Initial | Discharge |
|---|---|---|---|---|---|
| Polymerization | Percent | | occupation | discharge | voltage after |
| degree of | occupation of | | of crack on | voltage | 5,000 hours |
| thickening | thickening agent | | catalyst layer | (relative value) | (relative value) |
| agent | (%) | Value B | (%) | (%) | (%) |
| 2,000 | 10 | 1.2+ | 10 | 110 | 110 |
| 2,000 | 13 | 1.2− | 8 | 110 | 111 |
| 200 | 33 | 0.9− | 8 | 105 | 105 |
| 200 | 35 | 1.2− | 7 | 90 | 92 |
| — | 0 | 21+ | 50 | 105 | 105 |

As can be seen in Table 4, the incorporation of a thickening agent in the polymer electrolyte coating compound causes the rise of the viscosity of the polymer electrolyte coating compound in a low shear rate range and hence the reduction of the difference in viscosity from the cathode catalyst coating compound in the same range. It is obvious that MEA having a drastically reduced percent occupation of crack on the cathode catalyst layer (i.e., drastically inhibited occurrence of crack) can be obtained during this procedure.

It can be also seen in the results of value B that when the viscosity of the polymer electrolyte coating compound which is an undercoat layer is relatively greater, the effect of inhibiting the occurrence of crack on the cathode catalyst layer can be more exerted.

Further, referring to cell properties, it is obvious that when the content of the thickening agent is 33% by weight or less, properties which are not poorer than that obtained when no thickening agent is added are obtained. It is presumed that when the amount of the thickening agent to be added increases, the occurrence of crack on the cathode catalyst layer can be inhibited to exert effectively the effect of enhancing the cell properties, but the content of thickening agent components having no hydrogenionic conductivity in the polymer electrolyte layer increases at the same time to exert an effect of deteriorating the cell properties.

### EXAMPLE 5

In the present example, a test on the incorporation of a gelatinizing agent in the polymer electrolyte coating compound was made.

As the gelatinizing agent there was used a temperature-sensitive gelatinizing latex (produced by Sanyo Chemical Industries, Ltd.) which is a temperature-sensitive gelatinizing agent. When heated, this material changes from liquid to gelatinous at a temperature of from 55° C. to 75° C. In the present example, polymer electrolyte coating compounds comprising a nonvolatile component of temperature-sensitive gelatinizing latex in an amount of 5% by weight, 7% by weight, 30% by weight and 33% by weight, respectively, were studied. As the polymer electrolyte coating compound which is a base there was used a 24% dispersion of perfluoroethylenesulfonic acid as used in said examples.

As the cathode catalyst coating compound there was used a catalyst coating compound containing a propylene glycol-n-butyl ether as a solvent in an amount of 40% by weight as used in Example 1. The percent occupation of crack on the cathode catalyst layer during the preparation of MEA and the properties of single cell assembled by MEA were then evaluated in the same manner as in Example 1. The results are set forth in Table 5 together with the results of the case where no thickening agent is incorporated.

TABLE 5

| Content of | Percent | Initial | Discharge |
|---|---|---|---|
| temperature- | occupation | discharge | voltage after |
| sensitive | of crack on | voltage | 5,000 hours |
| gelatinizing agent | catalyst layer | (relative value) | (relative value) |
| (wt %) | (%) | (%) | (%) |
| 0 | 50 | 105 | 105 |
| 5 | 11 | 111 | 110 |
| 7 | 9 | 110 | 110 |
| 33 | 8 | 105 | 105 |
| 35 | 7 | 90 | 92 |

As can be seen in Table 5, the incorporation of a gelatinizing agent in the polymer electrolyte layer coating compound makes it possible to obtain MEA having a drastically reduced occupation of crack on the cathode catalyst layer. This is presumably attributed to the fact that the polymer electrolyte coating compound is gelatinized before the evaporation of the solvent from the cathode catalyst coating compound to inhibit the contractional movement of the polymer electrolyte coating compound layer, resulting in the inhibition of the occurrence of crack on the cathode catalyst layer.

It can also been seen that when the content of the gelatinizing agent is 33% by weight or less, the cell properties are further enhanced. As in the case of the thickening agent in Example 4, when the amount of the gelatinizing agent to be added increases, the occurrence of crack on the cathode catalyst layer is inhibited to exert an effect of enhancing the cell properties, but the content of gelatinizing agent components having no hydrogenionic conductivity in the polymer electrolyte layer increases at the same time. Thus, it can be said that the content of the gelatinizing agent is preferably 33% by weight or less.

### INDUSTRIAL APPLICABILITY

As can be seen in the foregoing description, the present invention can provide a method of producing a membrane-electrode assembly for fuel cell, an apparatus of producing a membrane-electrode assembly for fuel cell and a membrane-electrode assembly which remarkably enhances the productivity and properties of fuel cell.

Further, the present invention can provide a method of producing a membrane-electrode assembly for fuel cell and an apparatus of producing a membrane-electrode assembly for fuel cell having a high productivity.

Further, the present invention can provide a method of producing a membrane-electrode assembly for fuel cell and an apparatus of producing a membrane-electrode assembly for fuel cell which is not subject to deterioration of electrical properties caused by the penetration of the electrolyte layer coating compound into the voids formed in a first catalyst layer.

Further, the present invention can provide a method of producing a membrane-electrode assembly for fuel cell and an apparatus of producing a membrane-electrode assembly for fuel cell which is not subject to deterioration of electrical properties even when a coating compound which is a raw material of electrolyte and a coating compound which is a raw material of second coating compound are simultaneously spread.

Further, the present invention can provide a membrane-electrode assembly having a lower internal resistance than ever.

Further, the present invention can provide a method of producing a membrane-electrode assembly for fuel cell having stable electricity-generating properties which shows little structural defects such as crack on the catalyst layer and separation of catalyst layer and polymer electrolyte layer from each other. Moreover, the use of a membrane-electrode assembly for fuel cell prepared by the aforementioned production method makes it possible to obtain a fuel cell having excellent properties. Further, a polymer electrolyte coating compound which realizes said fuel cell having excellent properties can be obtained.

1-5. (canceled)

6. A method of producing a membrane-electrode assembly for fuel cell comprising:
a first step of spreading a first coating compound comprising a first catalyst and a resin having hydrogenionic conductivity over a substrate to form a first layer;
a second step of spreading a second coating compound comprising a resin having hydrogenionic conductivity over said first layer to form a second layer; and
a third step of spreading a third coating compound comprising a second catalyst, a resin having hydrogenionic conductivity and a solvent over said second layer before drying of said second layer to form a third layer and prepare a laminate comprising said first layer, said second layer and said third layer,
wherein said solvent contains an organic solvent having a boiling point of 120° C. or more at 1 atm in a proportion of 40% by weight or more; and
90% or more of the drying step of drying said laminate is effected at a temperature of from 60° C. to 80° C.

7. A method of producing a membrane-electrode assembly for fuel cell comprising:
a first step of spreading a first coating compound comprising a first catalyst and a resin having hydrogenionic conductivity over a substrate to form a first layer;
a second step of spreading a second coating compound comprising a resin having hydrogenionic conductivity over said first layer to form a second layer; and
a third step of spreading a third coating compound comprising a second catalyst, a resin having hydrogenionic conductivity and a solvent over said second layer before drying of said second layer to form a third layer and prepare a laminate comprising said first layer, said second layer and said third layer,
wherein said solvent contains an organic solvent having a saturated vapor pressure of 1.06 kPa (8 mmHg) or less at 20° C. in a proportion of 40% by weight or more; and
90% or more of the drying step of drying said laminate is effected at a temperature of from 60° C. to 80° C.

8. A method of producing a membrane-electrode assembly for fuel cell of claim 7, wherein said solvent contains an organic solvent having a saturated vapor pressure of 0.20 kPa (1.5 mmHg) or less at 200C.

9. A method of producing a membrane-electrode assembly for fuel cell of any one of claims 6 to 8, wherein said organic solvent contains a compound represented by the following general formula (A):
R₁—O—(R₂O)ₙ—H (A)
wherein R₁ is one functional group selected from CH₃, C₂H₅, C₃H₇ and C₄H₉;
R₂ is one functional group selected from C₂H₄ and C₃H₆; and
n is one integer selected from 1, 2 and 3.

10. A membrane-electrode assembly for fuel cell comprising:
a first step of spreading a first coating compound comprising a first catalyst and a resin having hydrogenionic conductivity over a substrate to form a first layer;
a second step of spreading a second coating compound comprising a resin having hydrogenionic conductivity over said first layer to form a second layer; and
a third step of spreading a third coating compound comprising a second catalyst, a resin having hydrogenionic conductivity and a solvent over said second layer to form a third layer and prepare a laminate comprising said first layer, said second layer and said third layer,
wherein said second coating compound contains a gelatinizing agent.

11. A method of producing a membrane-electrode assembly for fuel cell of claim 10, wherein said gelatinizing agent is a temperature-sensitive gelatinizing agent.

12. A method of producing a membrane-electrode assembly for fuel cell of claim 10 or 11, wherein said second coating compound contains said gelatinizing agent in a proportion of 33% by weight or less.

13. A method of producing a membrane-electrode assembly for fuel cell of any one of claims 6, 7 and 10, wherein said second compound contains a thickening agent in a proportion of 33% by weight or less.

14. A method of producing a membrane-electrode assembly for fuel cell of any one of claims 6, 7 and 10, wherein the viscosity η₁ of said second coating compound at a temperature of 25° C. and a shear rate of 1 s⁻¹ and the viscosity 12 of said third coating compound at a temperature of 25° C. and a shear rate of 1 s⁻¹ satisfy the following relationship:
1/25≦η₁/η₂≦25
wherein η₁ and η₂ each are greater than 0.

15. A method of producing a membrane-electrode assembly for fuel cell of claim 14, wherein said η₁ and said η₂ satisfy the relationship η₁>η₂.

16. A method of producing a membrane-electrode assembly for fuel cell of any one of claims 6, 7 and 10, wherein said second catalyst is a solid material having a noble metal supported thereon; and said third coating compound is a coating compound obtained by a step comprising kneading said second catalyst and a first solvent which is at least one component of said solvent with the proportion of said second catalyst being 20% by weight or more.

17. A method of producing a membrane-electrode assembly for fuel cell of claim 16, wherein said first solvent is a solvent having the highest affinity for said catalyst among said solvent components.

18. A method of producing a membrane-electrode assembly for fuel cell of any one of claims 6, 7 and 10, wherein said first step, said second step and said third step are sequentially effected while said substrate is being continuously carried.

19. A polymer electrolyte type fuel cell comprising a membrane-electrode assembly for fuel cell produced by a method of producing a membrane-electrode assembly for fuel cell of any one of claims 6, 7 and 10 and a separator through which a reactive gas is supplied into said membrane-electrode assembly for fuel cell.

20. A polymer electrolyte coating compound for fuel cell comprising a resin having hydrogenionic conductivity, a second solvent capable of dissolving said resin therein and a gelatinizing agent.

21. A polymer electrolyte coating compound for fuel cell of claim 20, wherein said gelatinizing agent is a temperature-sensitive gelatinizing agent.

22. A polymer electrolyte coating compound for fuel cell of claim 20 or 21, wherein said gelatinizing agent is incorporated in a proportion of 33% by weight or less.

23. A membrane-electrode assembly for fuel cell comprising a pair of catalyst layers laminated on each other with a polymer electrolyte layer having hydrogenionic conductivity interposed therebetween, wherein said polymer electrolyte layer is porous.

24. A polymer electrolyte type fuel cell comprising a membrane-electrode assembly for fuel cell of claim 23 and a separator through which a reactive gas is supplied into said membrane-electrode assembly for fuel cell.

25. A method of producing a membrane-electrode assembly for fuel cell comprising:
a first catalyst layer forming step of spreading a first coating compound over a running substrate to form a first catalyst layer;
an electrolyte forming step of spreading a second coating compound over said first catalyst layer while said first catalyst layer is wet to form an electrolyte layer;
a drying step of drying said electrolyte layer such that the thickness of said electrolyte layer kept in wet state reaches a predetermined value; and
a second catalyst layer forming step of spreading a third coating compound over said dried electrolyte layer to form a second catalyst layer, wherein said first catalyst layer and said second catalyst layer are a hydrogen electrode and an oxygen electrode, respectively, or an oxygen electrode and a hydrogen electrode, respectively.

26. The method of producing a membrane-electrode assembly for fuel cell as described in claim 25, wherein said drying step is effected at a drying temperature of from not lower than 20° C. to not higher than 150° C.

27. The method of producing a membrane-electrode assembly for fuel cell as described in claim 26, wherein said drying step is effected with the distance between the outlet of hot air and said electrolyte layer falling within the range of from not smaller than 10 mm to not greater than 500 mm.

28. The method of producing a membrane-electrode assembly for fuel cell as described in claim 27, wherein said drying step is effected with the hot air flow rate at a position of 10 mm from said outlet of hot air falling within the range of from not smaller than 1 m per second to not greater than 20 m per second.

29. An apparatus of producing a membrane-electrode assembly for fuel cell comprising:
a first catalyst layer forming unit of spreading a first coating compound over a running substrate to form a first catalyst layer;
an electrolyte forming unit of spreading a second coating compound over said first catalyst layer thus formed while said first catalyst layer is wet to form an electrolyte layer;
a drying unit of drying said electrolyte layer such that the thickness of said electrolyte layer kept in wet state reaches a predetermined value; and
a second catalyst layer forming unit of spreading a third coating compound over said dried electrolyte layer to form a second catalyst layer,
wherein said first catalyst layer and said second catalyst layer are a hydrogen electrode and an oxygen electrode, respectively, or an oxygen electrode and a hydrogen electrode, respectively.

30. A membrane-electrode assembly for fuel cell comprising:
a hydrogen electrode;
an electrolyte layer formed on said hydrogen electrode; and
an oxygen electrode formed on said electrolyte layer,
wherein said oxygen electrode has a larger area in contact with said electrolyte layer than said hydrogen electrode.
